(19) United States
(12) Patent Application Publication
(10) Pub. No.: US 2024/0359429 A1
(43) Pub. Date: Oct. 31, 2024

(54) Gypsum Panel Having Enhanced Hail Resistance

(71) Applicant: Gold Bond Building Products, LLC, Charlotte, NC (US)

(72) Inventors: Brian G. Randall, Charlotte, NC (US); Brian Bland, Matthews, NC (US); Joseph J. Bailey, Charlotte, NC (US)

(21) Appl. No.: 18/645,773

(22) Filed: Apr. 25, 2024

Related U.S. Application Data
(60) Provisional application No. 63/498,607, filed on Apr. 27, 2023.

(51) Int. Cl. B32B 13/14; B32B 5/02; B32B 37/24; C04B 28/14; C04B 111/00

(52) U.S. Cl. CPC B32B 13/14; B32B 5/02; B32B 37/24; C04B 28/14; B32B 2250/40; B32B 2260/023; B32B 2260/046; B32B 2262/101; B32B 2262/16; B32B 2307/30; B32B 2307/558; B32B 2307/718; B32B 2307/72; B32B 2318/00; B32B 2419/06; C04B 2111/00586; C04B 2111/00629

(57) ABSTRACT

The present invention is directed to a gypsum panel with enhanced hail resistance and a method of making such gypsum panel. For instance, in one aspect, the gypsum panel comprises a gypsum core and a first facing material and a second facing material, the first facing material and the second facing material sandwiching the gypsum core, the first facing material, the second facing material, or both comprising glass fibers and one or more binders, the glass fibers being bound by the one or more binders. The methods of the present invention are directed to making the aforementioned gypsum panels by providing the first facing material, providing a gypsum slurry comprising gypsum and water onto the first facing material, and providing a second facing material on the gypsum slurry.

### RELATED APPLICATIONS

The present application is based on and claims priority to U.S. Provisional Patent Application Ser. No. 63/498,607, filed on Apr. 27, 2023, which is incorporated herein by reference in its entirety.

### BACKGROUND OF THE INVENTION

Gypsum panels are commonly employed in drywall construction of interior walls and ceilings and also have other applications. Generally, these gypsum panels are formed from a gypsum slurry including a mixture of calcined gypsum (i.e., stucco), water, and other conventional additives. The mixture is cast and allowed to set by reaction of the stucco with the water. Notably, in various applications, gypsum panels may be utilized as roofing gypsum panels. However, traditional roofing gypsum panels may have limited hail resistance. Indeed, the limited hail resistance of traditional roofing gypsum panels may result in the deterioration of a building structure, may incur significant costs, and may even expose the contents of a building structure, such as equipment or people, to dangerous environmental conditions.

As a result, there is a need to provide an improved gypsum panel that has enhanced hail resistance.

### SUMMARY OF THE INVENTION

Aspects and advantages of the invention will be set forth in part in the following description, or may be obvious from the description, or may be learned through practice of the invention.

In accordance with one embodiment of the present invention, a gypsum panel is disclosed. The gypsum panel comprises a gypsum core, the gypsum core comprising gypsum; and a first facing material and a second facing material, the first facing material and the second facing material sandwiching the gypsum core, the first facing material, the second facing material, or both comprising glass fibers and one or more binders, the glass fibers being bound by the one or more binders, the one or more binders being present in the first facing material, the second facing material, or both in an amount from about 10 wt. % to about 50 wt. %.

In accordance with another embodiment of the present invention, a method of making a gypsum panel is disclosed. The method comprises providing a first facing material; depositing a gypsum slurry comprising stucco, water onto the first facing material, providing a second facing material on the gypsum slurry; allowing the stucco to convert to calcium sulfate dihydrate; and wherein the first facing material, the second facing material, or both comprise glass fibers and one or more binders, the glass fibers being bound by the one or more binders, the one or more binders being present in the first facing material, the second facing material, or both in an amount from about 10 wt. % to about 50 wt. %.

### DETAILED DESCRIPTION

Reference now will be made in detail to various embodiments. Each example is provided by way of explanation of the embodiments, not as a limitation of the present disclosure. In fact, it will be apparent to those skilled in the art that various modifications and variations can be made to the embodiments without departing from the scope or spirit of the present disclosure. For instance, features illustrated or described as part of one embodiment can be used with another embodiment to yield a still further embodiment. Thus, it is intended that aspects of the present disclosure cover such modifications and variations.

Generally speaking, the present invention is directed to a gypsum panel and a method of making such gypsum panel. In particular, the gypsum panel can include a facing material bound by a polymeric binder. In this regard, the gypsum panel may include a first facing material bound by a polymeric binder and/or a second facing material bound by a polymeric binder. The present inventors have discovered that the gypsum panel disclosed herein can have various benefits due to the use of a polymeric binder in one or more of the facing materials of a gypsum panel. For instance, the present inventors have discovered that the mechanical properties and characteristics of the gypsum panel may be improved. For instance, the gypsum panel disclosed herein may have increased panel strength, increased puncture resistance, and/or increased hail resistance. Notably, in one aspect, a gypsum panel formed in accordance with the present disclosure may be utilized as a roofing panel.

It should be understood that throughout the entirety of this specification, each numerical value (e.g., weight percentage, concentration) disclosed should be read as modified by the term “about”, unless already expressly so modified, and then read again as not to be so modified. For instance, a value of “100” is to be understood as disclosing “100” and “about 100”. Further, it should be understood that throughout the entirety of this specification, when a numerical range (e.g., weight percentage, concentration) is described, any and every amount of the range, including the end points and all amounts therebetween, is disclosed. For instance, a range of “1 to 100”, is to be understood as disclosing both a range of “1 to 100 including all amounts therebetween” and a range of “about 1 to about 100 including all amounts therebetween”. The amounts therebetween may be separated by any incremental value. Notably, some aspects of the present invention may omit one or more of the features disclosed herein.

It should be understood that a cement panel may be formed in accordance with the present disclosure. In one aspect, the cement panel may comprise Portland cement. Generally, a cement panel may include a cement core and one or more facing materials (e.g., first facing material, second facing material). The cement core and/or one or more facing materials may include any of the additives (e.g., polymeric binder) disclosed herein in any amounts disclosed herein. A cement panel formed in accordance with the present disclosure may possess any of the properties (e.g., nail pull strength, compressive strength, etc.) and/or characteristics disclosed herein.

In another aspect, the panel may be a gypsum panel including a gypsum core and one or more facing materials. In general, the gypsum core may comprise calcium sulfate dihydrate. The gypsum may be from a natural source, a synthetic source, and/or reclaim and is thus not necessarily limited by the present invention. In general, the gypsum, in particular the calcium sulfate dihydrate, is present in the gypsum core in an amount of at least 50 wt. %, such as at least 60 wt. %, such as at least 70 wt. %, such as at least 80 wt. %, such as at least 90 wt. %, such as at least 95 wt. %, such as at least 98 wt. %, such as at least 99 wt. %. The gypsum is present in an amount of 100 wt. % or less, such as 99 wt. % or less, such as 98 wt. % or less, such as 95 wt. % or less, such as 90 wt. % or less based on the weight of the solids in the gypsum slurry. In one embodiment, the aforementioned weight percentages are based on the weight of the gypsum core. In another embodiment, the aforementioned weight percentages are based on the weight of the gypsum panel.

Generally, the core (e.g., cement core, gypsum core) may be sandwiched by facing materials (e.g., first facing material, second facing material). The facing materials may include any facing material as generally employed in the art. For instance, the facing material may be a paper facing material, a fibrous (e.g., glass fiber) mat facing material (e.g., glass mat facing material), a metal facing material (e.g., an aluminum facing material), or a polymeric facing material. In general, the first facing material and the second facing material may be the same type of material. Alternatively, the first facing material may be one type of material while the second facing material may be a different type of material. In one aspect, the first facing material and the second facing material may comprise the same binder (e.g., a polymeric binder). In another aspect, the first facing material and the second facing material may comprise a different binder. In an additional aspect, the first facing material and/or the second facing material may not comprise a polymeric binder.

Notably, the first facing material and/or the second facing material may be a nonwoven glass mat facing material. In this respect, a facing material of a gypsum panel formed in accordance with the present disclosure may comprise glass fibers. The glass fibers may have a selectively chosen average fiber diameter. Notably, as the average fiber diameter of the glass fibers increases, the strength, puncture resistance, impact resistance, and/or hail resistance of a gypsum panel may increase.

In general, the glass fibers may have an average fiber diameter of about 5 microns to about 25 microns, including all increments of 1 nanometer therebetween. The glass fibers may have an average fiber diameter of about 25 microns or less, such as about 24 microns or less, such as about 23 microns or less, such as about 22 microns or less, such as about 21 microns or less, such as about 20 microns or less, such as about 19 microns or less, such as about 18 microns or less, such as about 17 microns or less, such as about 16 microns or less, such as about 15 microns or less, such as about 14 microns or less, such as about 13 microns or less, such as about 12 microns or less, such as about 11 microns or less, such as about 10 microns or less, such as about 9 microns or less, such as about 8 microns or less, such as about 7 microns or less, such as about 6 microns or less. Generally, the glass fibers may have an average fiber diameter of about 5 microns or more, such as about 6 microns or more, such as about 7 microns or more, such as about 8 microns or more, such as about 9 microns or more, such as about 10 microns or more, such as about 11 microns or more, such as about 12 microns or more, such as about 13 microns or more, such as about 14 microns or more, such as about 15 microns or more, such as about 16 microns or more, such as about 17 microns or more, such as about 18 microns or more, such as about 19 microns or more, such as about 20 microns or more, such as about 21 microns or more, such as about 22 microns or more, such as about 23 microns or more, such as about 24 microns or more. Furthermore, in one aspect, the aforementioned values may refer to a median glass fiber diameter. Notably, in one preferred aspect, the glass fibers may have an average fiber diameter from about 13 microns to about 18 microns.

In general, the glass fibers may have a selectively chosen average fiber length. For instance, the glass fibers may have an average fiber length of about 0.5 inches to about 1.5 inches, including all increments of 0.01 inches therebetween. In general, the glass fibers may have an average fiber length of about 0.5 inches or more, such as about 0.6 inches or more, such as about 0.7 inches or more, such as about 0.8 inches or more, such as about 0.9 inches or more, such as about 1.0 inch or more, such as about 1.1 inches or more, such as about 1.2 inches or more, such as about 1.3 inches or more, such as about 1.4 inches or more. Generally, the glass fibers may have an average fiber length of about 1.5 inches or less, such as about 1.4 inches or less, such as about 1.3 inches or less, such as about 1.2 inches or less, such as about 1.1 inches or less, such as about 1.0 inch or less, such as about 0.9 inches or less, such as about 0.8 inches or less, such as about 0.7 inches or less, such as about 0.6 inches or less. Furthermore, in one aspect, the aforementioned values may refer to a median glass fiber length.

In general, the glass fibers may comprise a first portion of glass fibers and a second portion of glass fibers. Notably, the glass fibers of the first portion of glass fibers may have a larger average fiber diameter and/or a larger average fiber length than the glass fibers of the second portion of glass fibers. The second portion of glass fibers may comprise glass microfibers. Notably, glass microfibers may be included in one or more facing materials to increase the strength of a gypsum panel and/or reduce bleed through.

In general, the glass fibers of the present disclosure may comprise glass microfibers. For instance, a second portion of glass fibers may comprise glass microfibers. The glass microfibers may have an average fiber diameter of about 1 micron to about 6 microns, including all increments of 1 nanometer therebetween. For instance, the glass microfibers may have an average fiber diameter of about 1 micron or more, such as about 2 microns or more, such as about 3 microns or more, such as about 4 microns or more, such as about 5 microns or more. Generally, the glass microfibers may have an average fiber diameter of about 6 microns or less, such as about 5 microns or less, such as about 4 microns or less, such as about 3 microns or less, such as about 2 microns or less. Furthermore, in one aspect, the aforementioned values may refer to a median glass microfiber diameter.

Notably, the glass microfibers may have an average fiber length of about 0.1 inches to about 0.4 inches, including all increments of 0.01 inches therebetween. For instance, the glass microfibers may have an average fiber length of about 0.1 inches or more, such as about 0.125 inches or more, such as about 0.2 inches or more, such as about 0.25 inches or more, such as about 0.3 inches or more. Generally, the glass microfibers may have an average fiber length of about 0.4 inches or less, such as about 0.3 inches or less, such as about 0.25 inches or less, such as about 0.2 inches or less, such as about 0.125 inches or less. Furthermore, in one aspect, the aforementioned values may refer to a median glass microfiber length.

Generally, glass microfibers may be present in the glass fibers in an amount of about 1 wt. % to about 40 wt. %, including all increments of 1 wt. % therebetween, by weight of the glass fibers. For instance, glass microfibers may be present in the glass fibers in an amount of about 1 wt. % or more, such as about 2 wt. % or more, such as about 5 wt. % or more, such as about 8 wt. % or more, such as about 10 wt. % or more, such as about 20 wt. % or more, such as about 30 wt. % or more. In general, the glass microfibers may be present in the glass fibers in an amount of about 40 wt. % or less, such as about 30 wt. % or less, such as about 20 wt. % or less, such as about 10 wt. % or less, such as about 8 wt. % or less, such as about 5 wt. % or less, such as about 2 wt. % or less. Furthermore, in one aspect, the aforementioned values may refer to the amount of glass microfibers present in a facing material by the weight of the facing material. In this respect, glass microfibers may be present in a facing material in an amount of about 1 wt. % to about 40 wt. %, including all increments of 1 wt. % therebetween, by weight of the facing material.

The glass fibers, which may include a first portion of glass fibers and a second portion of glass fibers, may be present in a glass mat facing material in an amount of about 50 wt. % to about 90 wt. % by weight of the glass mat facing material, including all increments of 0.1% therebetween. In general, the glass fibers may be present in a glass mat facing material in an amount of about 50 wt. % or more, such as about 55 wt. % or more, such as about 60 wt. % or more, such as about 65 wt. % or more, such as about 70 wt. % or more, such as about 75 wt. % or more, such as about 80 wt. % or more, such as about 85 wt. % or more. In general, the glass fibers may be present in a glass mat facing material in an amount of about 90 wt. % or less, such as about 85 wt. % or less, such as about 80 wt. % or less, such as about 75 wt. % or less, such as about 70 wt. % or less, such as about 65 wt. % or less, such as about 60 wt. % or less, such as about 55 wt. % or less.

In some aspects, the panel (e.g., gypsum panel, cement panel) may include a facing material comprising glass fibers bound by one or more binders. For instance, the first facing material and/or second facing material may comprise a polymeric binder, such as an acrylic polymer or copolymer. The binder may be any binder as generally known in the art. In some aspects, the binder may include an acrylic polymer or copolymer, a vinyl acetate polymer or copolymer, a styrene polymer or copolymer, a vinyl acrylic polymer or copolymer, a cellulose, a starch, or a combination thereof.

Notably, the second facing material may comprise a polymeric binder. In general, the presence of a polymeric binder in the second facing material may be particularly advantageous in enhancing a panel's strength, puncture resistance, and/or hail resistance. Without being bound by any particular theory, it is believed that the energy transferred from an object (e.g., hail) contacting or impacting a panel may not break and/or crack one or more components of a panel (e.g., first facing material, second facing material) when the second facing material comprises a polymeric binder.

Generally, the binder may include an acrylic (or acrylate) polymer or copolymer, a styrene acrylic copolymer, a styrene butadiene copolymer, a vinyl acrylic copolymer, or a combination thereof. Suitable unsaturated monomers for use in forming the binder are generally ethylenically unsaturated monomers and include vinylaromatic compounds (e.g. styrene, α-methylstyrene, o-chlorostyrene, and vinyltoluenes); 1,2-butadiene (i.e. butadiene); conjugated dienes (e.g. 1,3-butadiene and isoprene); α,β-monoethylenically unsaturated mono- and dicarboxylic acids or anhydrides thereof (e.g. acrylic acid, methacrylic acid, crotonic acid, dimethacrylic acid, ethylacrylic acid, allylacetic acid, vinylacetic acid maleic acid, fumaric acid, itaconic acid, mesaconic acid, methylenemalonic acid, citraconic acid, maleic anhydride, itaconic anhydride, and methylmalonic anhydride); esters of α,β-monoethylenically unsaturated mono- and dicarboxylic acids having 3 to 6 carbon atoms with alkanols having 1 to 12 carbon atoms (e.g. esters of acrylic acid, methacrylic acid, maleic acid, fumaric acid, or itaconic acid, with C1-C12, C1-C8, or C1-C4 alkanols such as ethyl, n-butyl, isobutyl and 2-ethylhexyl acrylates and methacrylates, ethyl acrylates, methyl acrylates, dimethyl maleate and n-butyl maleate); acrylamides and alkyl-substituted acrylamides (e.g. (meth)acrylamide, N-tert-butylacrylamide, and N-methyl(meth)acrylamide); (meth)acrylonitrile; vinyl and vinylidene halides (e.g. vinyl chloride and vinylidene chloride); vinyl esters of C1-C18 mono- or dicarboxylic acids (e.g. vinyl acetate, vinyl propionate, vinyl n-butyrate, vinyl laurate and vinyl stearate); C1-C4 hydroxyalkyl esters of C3-C6 mono- or dicarboxylic acids, especially of acrylic acid, methacrylic acid or maleic acid, or their derivatives alkoxylated with from 2 to 50 moles of ethylene oxide, propylene oxide, butylene oxide or mixtures thereof, or esters of these acids with C1-C18 alcohols alkoxylated with from 2 to 50 mol of ethylene oxide, propylene oxide, butylene oxide or mixtures thereof (e.g. hydroxyethyl(meth)acrylate, hydroxypropyl(meth)acrylate, and methylpolyglycol acrylate); and monomers containing glycidyl groups (e.g. glycidyl methacrylate).

Additional monomers that can be used in forming the binder include linear 1-olefins, branched-chain 1-olefins or cyclic olefins (e.g., ethene, propene, butene, isobutene, pentene, cyclopentene, hexene, and cyclohexene); vinyl and allyl alkyl ethers having 1 to 40 carbon atoms in the alkyl radical, wherein the alkyl radical can possibly carry further substituents such as a hydroxyl group, an amino or dialkylamino group, or one or more alkoxylated groups (e.g. methyl vinyl ether, ethyl vinyl ether, propyl vinyl ether, isobutyl vinyl ether, 2-ethylhexyl vinyl ether, vinyl cyclohexyl ether, vinyl 4-hydroxybutyl ether, decyl vinyl ether, dodecyl vinyl ether, octadecyl vinyl ether, 2-(diethylamino)ethyl vinyl ether, 2-(di-n-butylamino)ethyl vinyl ether, methyldiglycol vinyl ether, and the corresponding allyl ethers); sulfo-functional monomers (e.g. allylsulfonic acid, methallylsulfonic acid, styrenesulfonate, vinylsulfonic acid, allyloxybenzenesulfonic acid, 2-acrylamido-2-methylpropanesulfonic acid, and their corresponding alkali metal or ammonium salts, sulfopropyl acrylate and sulfopropyl methacrylate); vinylphosphonic acid, dimethyl vinylphosphonate, and other phosphorus monomers; alkylaminoalkyl(meth)acrylates or alkylaminoalkyl(meth)acrylamides or quaternization products thereof (e.g. 2-(N,N-dimethylamino)ethyl(meth)acrylate, 3-(N,N-dimethylamino)propyl(meth)acrylate, 2-(N,N,N-trimethylammonium)ethyl(meth)acrylate chloride, 2-dimethylaminoethyl(meth)acrylamide, 3-dimethylaminopropyl(meth)acrylamide, and 3-trimethylammoniumpropyl(meth)acrylamide chloride); allyl esters of C1-C30 monocarboxylic acids; N-Vinyl compounds (e.g. N-vinylformamide, N-vinyl-N-methylformamide, N-vinylpyrrolidone, N-vinylimidazole, 1-vinyl-2-methylimidazole, 1-vinyl-2-methylimidazoline, N-vinylcaprolactam, vinylcarbazole, 2-vinylpyridine, and 4-vinylpyridine); monomers containing 1,3-diketo groups (e.g. acetoacetoxyethyl(meth)acrylate or diacetonacrylamide; monomers containing urea groups (e.g. ureidoethyl(meth)acrylate, acrylamidoglycolic acid, and methacrylamidoglycolate methyl ether); and monomers containing silyl groups (e.g. trimethoxysilylpropyl methacrylate).

In one aspect, the binder may include a styrene butadiene copolymer. In particular, the styrene butadiene copolymer may be a modified copolymer. For instance, the styrene butadiene copolymer may be a carboxylated styrene butadiene copolymer. In another embodiment, the binder includes at least an acrylic polymer, such as methyl acrylate, butyl acrylate, or ethyl acrylate. In a further embodiment, the binder may include both of the aforementioned styrene butadiene copolymer and acrylic polymer.

As indicated above, the binder may include a vinyl acetate polymer or copolymer. In this regard, the binder may include a polyvinyl acetate, an ethylene vinyl acetate, etc., or a combination thereof.

As indicated above, the binder may include a cellulose, such as a cellulose ether. The cellulose ether may include a hydroxyethyl cellulose, a carboxymethyl cellulose, a hydroxypropyl cellulose, etc., or a combination thereof.

In one aspect, any of the monomers previously disclosed herein may be utilized to modify a urea formaldehyde binder to form a modified urea formaldehyde binder. In this respect, the modification of a urea formaldehyde binder with one or more monomers disclosed herein may result in the formation of an elastomeric urea formaldehyde binder.

Generally, a binder (e.g., polymeric binder) may be present in a facing material (e.g., glass mat facing material) in an amount from about 10 wt. % to about 50 wt. % by weight of the facing material, including all increments of 0.1% therebetween. In general, the binder may be present in a facing material in an amount of about 10 wt. % or more, such as about 15 wt. % or more, such as about 18 wt. % or more, such as about 20 wt. % or more, such as about 22 wt. % or more, such as about 25 wt. % or more, such as about 28 wt. % or more, such as about 30 wt. % or more, such as about 32 wt. % or more, such as about 35 wt. % or more, such as about 38 wt. % or more, such as about 40 wt. % or more, such as about 45 wt. % or more by weight of the facing material. Generally, the binder may be present in a facing material in an amount of about 50 wt. % or less, such as about 45 wt. % or less, such as about 40 wt. % or less, such as about 38 wt. % or less, such as about 35 wt. % or less, such as about 32 wt. % or less, such as about 30 wt. % or less, such as about 28 wt. % or less, such as about 25 wt. % or less, such as about 22 wt. % or less, such as about 20 wt. % or less, such as about 18 wt. % or less, such as about 15 wt. % or less by weight of the facing material. Such weight percentages may apply to a single binder or a combination of binders.

Notably, two or more binders may be present in a facing material. For instance, an acrylic binder and a urea formaldehyde binder (e.g., a modified urea formaldehyde binder) may be present in a facing material formed in accordance with the present disclosure. When two or more binders are present in a facing material, and one of the binders is an acrylic binder, the acrylic binder may be present in the facing material in an amount from about 51 wt. % to about 99 wt. % by weight of the two or more binders, including all increments of 1 wt. % therebetween. For instance, when two or more binders are present in a facing material, and one of the binders is an acrylic binder, the acrylic binder may be present in the facing material by weight of the two or more binders in an amount of about 51 wt. % or more, such as about 60 wt. % or more, such as about 70 wt. % or more, such as about 80 wt. % or more, such as about 90 wt. % or more. Generally, when two or more binders are present in a facing material, and one of the binders is an acrylic binder, the acrylic binder may be present in the facing material by weight of the two or more binders in an amount of about 99 wt. % or less, such as about 90 wt. % or less, such as about 80 wt. % or less, such as about 70 wt. % or less, such as about 60 wt. % or less.

Notably, a binder (e.g., a polymeric binder) may have a glass transition temperature of about −100° C. to about 150° C., including all increments of 1° C. therebetween. For instance, the binder may have a glass transition temperature of about −100° C. or more, such as about −80° C. or more, such as about −60° C. or more, such as about −40° C. or more, such as about −20° C. or more, such as about 0° C. or more, such as about 20° C. or more, such as about 40° C. or more, such as about 60° C. or more, such as about 80° C. or more, such as about 100° C. or more, such as about 120° C. or more. Generally, the binder may have a glass transition temperature of about 150° C. or less, such as about 120° C. or less, such as about 100° C. or less, such as about 80° C. or less, such as about 60° C. or less, such as about 40° C. or less, such as about 20° C. or less, such as about 0° C. or less, such as about −20° C. or less, such as about −40° C. or less, such as about −60° C. or less, such as about −80° C. or less.

In general, a facing material (e.g., glass mat facing material) formed in accordance with the present disclosure may have a basis weight from about 1.8 lbs/csf to about 3.2 lbs/csf. As used herein, “lbs/csf” refers to pounds per one hundred square feet. A facing material formed in accordance with the present disclosure may have a basis weight of about 1.8 lbs/csf or more, such as about 1.9 lbs/csf or more, such as about 2.0 lbs/csf or more, such as about 2.1 lbs/csf or more, such as about 2.2 lbs/csf or more, such as about 2.3 lbs/csf or more, such as about 2.4 lbs/csf or more, such as about 2.5 lbs/csf or more, such as about 2.6 lbs/csf or more, such as about 2.7 lbs/csf or more, such as about 2.8 lbs/csf or more, such as about 2.9 lbs/csf or more, such as about 3.0 lbs/csf or more, such as about 3.1 lbs/csf or more. Generally, a facing material formed in accordance with the present disclosure may have a basis weight of about 3.2 lbs/csf or less, such as about 3.1 lbs/csf or less, such as about 3.0 lbs/csf or less, such as about 2.9 lbs/csf or less, such as about 2.8 lbs/csf or less, such as about 2.7 lbs/csf or less, such as about 2.6 lbs/csf or less, such as about 2.5 lbs/csf or less, such as about 2.4 lbs/csf or less, such as about 2.3 lbs/csf or less, such as about 2.2 lbs/csf or less, such as about 2.1 lbs/csf or less, such as about 2.0 lbs/csf or less, such as about 1.9 lbs/csf or less.

In some aspects, a panel, in particular a gypsum panel, formed in accordance with the present disclosure may meet or comply with ASTM C1177/C117M-13 (2013). Further, a panel, in particular a gypsum panel, formed in accordance with the present disclosure may meet or comply with the requirements of Factory Mutual's moderate hail rating (i.e., MH rating), severe hail rating (i.e., SH rating), and/or very severe hail rating (i.e., VSH rating), each rating tested in accordance with FM 4470.

Generally, the Factory Mutual test for an MH rating and an SH rating are similar. The test for an MH rating and the test for an SH rating both involve the testing of a first panel and a second panel. The Factory Mutual test for determining whether a panel complies with the MH rating involves placing a 2 inch diameter steel ball above a first panel and dropping the steel ball from a height of 81 inches onto the surface of the first panel. The steel ball weighs about 1.19 lbs. The impact energy of the steel ball is about 8 ft-lb. The first panel is subjected to a minimum of ten impacts from the 1.19 lb steel ball. Next, a second panel is UV weathered for 1000 hours. The second panel then undergoes the same impact testing as the first panel.

The Factory Mutual test for determining whether a panel complies with the SH rating involves placing a 2 inch diameter steel ball above a first panel and dropping the steel ball from a height of 141.5 inches onto the surface of the first panel. The steel ball weighs about 1.19 lbs. The impact energy of the steel ball is about 14 ft-lb. The first panel is subjected to a minimum of ten impacts from the 1.19 lb steel ball. Next, a second panel is UV weathered for 1000 hours. The second panel then undergoes the same impact testing as the first panel.

The Factory Mutual test for determining whether a panel complies with the VSH rating involves shooting a 2 inch diameter ice ball out of an air cannon at a speed of about 152 ft/sec to about 160 ft/sec onto the surface of a first panel. The impact energy of the ice ball is from about 53 ft-lb to about 58 ft-lb. The ice balls utilized in this test are prepared in accordance with ANSI FM 4473. The first panel is subjected to a minimum of three impacts from ice balls. The three impacts are done in accordance with one test number, a combination of test numbers, or all of the test numbers in Table 1. The test numbers are indicative of the impact location of one or more ice balls for different configurations of a panel (e.g., gypsum panel, cement panel) and a substrate (e.g., existing, installed, or otherwise established or installed roofing structures comprising materials that may include, as non-limiting examples, gypsum, stone, ceramic, cement, wood, composite, or metal materials). The number before the impact location is indicative of the number of ice balls impacting said location.

TABLE 1

| Test No. | Configuration | Impact Locations |
|---|---|---|
| 1 | Fully adhered panel over mechanically | 1 - field-fabricated seam |
| | fastened substrate | 1 - field of panel |
| | | 1 - fastener/stress plate |
| 2 | Fully adhered panel over fully adhered | 1 - field-fabricated seam |
| | substrate | 2 - field of panel |
| 3 | Fully adhered panel over partially | 1 - field-fabricated seam |
| | adhered (ribbon applied) substrate | 1 - field of panel directly over ribbon |
| | | 1 - field of panel between ribbons |
| 4 | Partially adhered panel over fully | 1 - field-fabricated seam |
| | adhered substrate | 1 - field of panel directly over ribbon |
| | | 1 - field of panel between ribbons |
| 5 | Partially adhered panel over partially | 1 - field-fabricated seam |
| | adhered (ribbon applied) substrate | 1 - field of panel directly over ribbon |
| | | 1 - field of panel between ribbons |
| 6 | Mechanically fastened panel over | 1 - field-fabricated seam |
| | loose laid substrate | 1 - field of panel |
| | | 1 - fastener/stress plate |
| 7 | All other assemblies | Minimum of three impacts at critical |
| | | locations as determined by engineer. |

Next, a second panel is UV weathered for 1000 hours. The second panel then undergoes the same impact testing as the first panel. Next, a third panel is UV weathered for 1000 hours and heat aged for 1000 hours. The third panel then undergoes the same impact testing as the first panel.

To achieve or comply with a respective Factory Mutual rating, each panel is inspected for damage. The panel shall not show any signs of splitting or cracking under 10× magnification. For adhered configurations, minor separation of the panel from the substrate (e.g., existing, installed, or otherwise established or installed roofing structures comprising materials that may include, as non-limiting examples, gypsum, stone, ceramic, cement, wood, composite, or metal materials) directly beneath the impact area is acceptable for monolithic decks (e.g., structural concrete or gypsum) or lightweight insulating concrete insulation. To achieve a VSH rating, the substrate below the panel shall not crack. Notably, minor surface indentations in the substrate are allowed at the point of impact.

Notably, a panel (e.g., gypsum panel, cement panel) including one or more facing materials formed in accordance with the present disclosure may not include a scrim or reinforcing layer. In this respect, a panel formed in accordance with the present disclosure may have increased panel strength, increased puncture resistance, increased impact resistance, and increased hail resistance without the utilization of a scrim or reinforcing layer. In one aspect, a panel formed in accordance with the present disclosure may have one or more facing materials that are not adjacent to or positioned in relation with a scrim and/or a reinforcing layer.

In general, the panel weight of the gypsum panel is not necessarily limited. For instance, the gypsum panel may have a panel weight of about 1500 lbs/MSF or more, such as about 1600 lbs/MSF or more, such as about 1800 lbs/MSF or more, such as about 2000 lbs/MSF or more, such as about 2200 lbs/MSF or more, such as about 2400 lbs/MSF or more, such as about 2600 lbs/MSF or more, such as about 2800 lbs/MSF or more, such as about 3000 lbs/MSF or more, such as about 3200 lbs/MSF or more, such as about 3400 lbs/MSF or more, such as about 3500 lbs/MSF or more. Generally, the gypsum panel may have a panel weight of about 3600 lbs/MSF or less, such as about 3500 lbs/MSF or less, such as about 3400 lbs/MSF or less, such as about 3200 lbs/MSF or less, such as about 3000 lbs/MSF or less, such as about 2800 lbs/MSF or less, such as about 2600 lbs/MSF or less, such as about 2400 lbs/MSF or less, such as about 2200 lbs/MSF or less, such as about 2000 lbs/MSF or less, such as about 2000 lbs/MSF or less. Such panel weight may be a dry panel weight such as after the panel leaves the heating or drying device (e.g., kiln).

In one aspect, the flexural strength of the gypsum panel in the perpendicular direction (as determined in accordance with ASTM C473-19) may be about 90 lbf or more, such as about 100 lbf or more, such as about 110 lbf or more, such as about 130 lbf or more, such as about 150 lbf or more, such as about 160 lbf or more, such as about 175 lbf or more. The flexural strength in the perpendicular direction may be about 350 lbf or less, such as about 300 lbf or less, such as about 275 lbf or less, such as about 250 lbf or less, such as about 225 lbf or less, such as about 200 lbf or less, such as about 175 lbf or less, such as about 150 lbf or less, such as about 125 lbf or less.

In one aspect, the flexural strength of the gypsum panel in the parallel direction (as determined in accordance with ASTM C473-19) may be about 60 lbf or more, such as about 80 lbf or more, such as about 100 lbf or more, such as about 125 lbf or more, such as about 150 lbf or more, such as about 175 lbf or more, such as about 200 lbf or more, such as about 225 lbf or more, such as about 250 lbf or more. The flexural strength in the parallel direction may be about 300 lbf or less, such as about 275 lbf or less, such as about 250 lbf or less, such as about 225 lbf or less, such as about 200 lbf or less, such as about 175 lbf or less, such as about 150 lbf or less, such as about 125 lbf or less, such as about 100 lbf or less.

It should be understood that a glass mat facing material in accordance with the present disclosure may be coated, such as a coating that is applied to the surface of the mat. Notably, the coating of a glass mat facing material may include any of the binders (e.g., polymeric binders) previously disclosed herein. In some aspects, the coating may comprise a carbonate, such as calcium carbonate. However, in one particular embodiment, a glass mat facing material may not have a coating. In general, the base mat of a coated facing material may be acrylic.

In one aspect, the coating disclosed herein may be provided on the first facing material. In another embodiment, the coating is provided on the second facing material. In a further embodiment, the coating is provided on the first facing material and the second facing material.

The coating can be applied using various methods known in the art. For instance, the coating can be applied by using techniques including, but not limited to spraying, rolling, or coating the coating formulation onto the facing material. However, it should be understood that other methods as generally employed in the art may also be utilized.

In general, the coating may be provided in an amount of 0.001 lbs/MSF or more, such as 0.01 lbs/MSF or more, such as 0.05 lbs/MSF or more, such as 0.1 lbs/MSF or more, such as 0.2 lbs/MSF or more, such as 0.25 lbs/MSF or more, such as 0.5 lbs/MSF or more, such as 0.75 lbs/MSF or more, such as 1 lb/MSF or more, such as 1.5 lbs/MSF or more, such as 2 lbs/MSF or more, such as 2.5 lbs/MSF or more, such as 3 lbs/MSF or more, such as 4 lbs/MSF or more, such as 5 lbs/MSF or more, such as 8 lbs/MSF or more, such as 10 lbs/MSF or more, such as 15 lbs/MSF or more, such as 20 lbs/MSF or more, such as 30 lbs/MSF or more, such as 40 lbs/MSF or more, such as 50 lbs/MSF or more, such as 60 lbs/MSF or more, such as 70 lbs/MSF or more, such as 80 lbs/MSF or more. Generally, the coating may be provided in an amount of 90 lbs/MSF or less, such as 80 lbs/MSF or less, such as 70 lbs/MSF or less, such as 60 lbs/MSF or less, such as 50 lbs/MSF or less, such as 40 lbs/MSF or less, such as 30 lbs/MSF or less, such as 25 lbs/MSF or less, such as 20 lbs/MSF or less, such as 15 lbs/MSF or less, such as 10 lbs/MSF or less, such as 5 lbs/MSF or less, such as 4 lbs/MSF or less, such as 3 lbs/MSF or less, such as 2.5 lbs/MSF or less, such as 2 lbs/MSF or less, such as 1.5 lbs/MSF or less, such as 1 lb/MSF or less. Alternatively, or in addition, the coating may be impregnated in the facing material in any of the amounts previously disclosed. In this respect, a coating may be impregnated in a facing material in an amount of from 0.001 lbs/MSF to 90 lbs/MSF, including all increments of 0.001 lbs/MSF therebetween.

Notably, the coating may comprise a carbonate, such as calcium carbonate, in an amount of about 5 wt. % or more, such as about 10 wt. % or more, such as about 20 wt. % or more, such as about 30 wt. % or more, such as about 40 wt. % or more, such as about 50 wt. % or more, such as about 60 wt. % or more, such as about 70 wt. % or more, such as about 80 wt. % or more, such as about 90 wt. % or more. In general, the coating may comprise a carbonate, such as calcium carbonate, in an amount of about 100 wt. % or less, such as about 90 wt. % or less, such as about 80 wt. % or less, such as about 70 wt. % or less, such as about 60 wt. % or less, such as about 50 wt. % or less, such as about 40 wt. % or less, such as about 30 wt. % or less, such as about 20 wt. % or less, such as about 10 wt. % or less.

Notably, the coating may be applied to the facing material prior to forming the panel, such as a gypsum panel. For instance, the facing material may be pre-coated. Alternatively, the coating may be applied to the facing material in-line during the production of the panel, such as a gypsum panel. For instance, the coating may be applied to the facing material prior to deposition of the slurry, such as the gypsum slurry, such that the coating has sufficient time to dry. Alternatively, the coating may be applied after deposition of the slurry, such as the gypsum slurry.

Notably, in one aspect, the second facing material may have a higher basis weight than the first facing material. In general, the glass fibers of the second facing material may have a larger average fiber diameter and/or a larger average fiber length than the glass fibers of the first facing material. Additionally, in one aspect, the second facing material may include a polymeric binder having a glass transition temperature that is different from the glass transition temperature of a polymeric binder included in the first facing material.

In general, the composition of the gypsum core is not necessarily limited and may include any additives as known in the art. For instance, the additives may include dispersants, foam or foaming agents including aqueous foam (e.g. sulfates), set accelerators (e.g., ball mill accelerator, land plaster, sulfate salts, etc.), set retarders, binders, biocides (such as bactericides and/or fungicides), adhesives, pH adjusters, thickeners (e.g., silica fume, Portland cement, fly ash, clay, celluloses, high molecular weight polymers, etc.), leveling agents, non-leveling agents, colorants, fire retardants or additives (e.g., silica, silicates, expandable materials such as vermiculite, perlite, etc.), water repellants (e.g., waxes, silicones, siloxanes, etc.), fillers (e.g., glass spheres, glass fibers), natural and synthetic fibers (e.g. cellulosic fibers, microfibrillated fibers, nanocellulosic fibers, etc.), acids (e.g., boric acid), secondary phosphates (e.g., condensed phosphates or orthophosphates including trimetaphosphates, polyphosphates, and/or cyclophosphates, etc.) and/or other phosphate derivatives (e.g., fluorophosphates, etc.), natural and synthetic polymers, starches (e.g., pregelatinized starch, non-pregelatinized starch, and/or a modified starch, such as an acid modified starch), sound dampening polymers (e.g., viscoelastic polymers/glues, such as those including an acrylic/acrylate polymer, etc.; polymers with low glass transition temperature, etc.), and mixtures thereof. In general, it should be understood that the types and amounts of such additives are not necessarily limited by the present invention.

Each additive of the gypsum core may be present in the gypsum core in an amount of 0.0001 wt. % or more, such as 0.001 wt. % or more, such as 0.01 wt. % or more, such as 0.02 wt. % or more, such as 0.05 wt. % or more, such as 0.1 wt. % or more, such as 0.15 wt. % or more, such as 0.2 wt. % or more, such as 0.25 wt. % or more, such as 0.3 wt. % or more, such as 0.5 wt. % or more, such as 1 wt. % or more, such as 2 wt. % or more. The additive may be present in an amount of 20 wt. % or less, such as 15 wt. % or less, 10 wt. % or less, such as 7 wt. % or less, such as 5 wt. % or less, such as 4 wt. % or less, such as 3 wt. % or less, such as 2.5 wt. % or less, such as 2 wt. % or less, such as 1.8 wt. % or less, such as 1.5 wt. % or less, such as 1 wt. % or less, such as 0.8 wt. % or less, such as 0.6 wt. % or less, such as 0.5 wt. % or less, such as 0.4 wt. % or less, such as 0.35 wt. % or less, such as 0.3 wt. % or less, such as 0.2 wt. % or less, such as 0.15 wt. % or less. The weight percentage may be based on the weight of the gypsum panel. Further, the weight percentage may be based on the weight of the gypsum core. In a further embodiment, such weight percentage may be based on the weight of a respective gypsum core layer. In an even further embodiment, the aforementioned weight percentages may be based on the solids content of the gypsum slurry. Moreover, the aforementioned weight percentages may be based on the weight of the stucco in the gypsum slurry. Additionally, the aforementioned weight percentages may be based on the weight of the gypsum in the gypsum core. In an additional embodiment, the aforementioned weight percentages may be based on the weight of the gypsum in the respective facing material. In yet another embodiment, the aforementioned weight percentages may be based on the weight of the gypsum in the respective gypsum core layer.

In general, the composition of the gypsum slurry and gypsum core is not necessarily limited and may be any generally known in the art. Generally, in one embodiment, the gypsum core is made from a gypsum slurry including at least stucco and water.

In general, stucco may be referred to as calcined gypsum or calcium sulfate hemihydrate. The calcined gypsum may be from a natural source or a synthetic source and is thus not necessarily limited by the present invention. In addition to the stucco, the gypsum slurry may also contain some calcium sulfate dihydrate or calcium sulfate anhydrite. If calcium sulfate dihydrate is present, the hemihydrate is present in an amount of at least 50 wt. %, such as at least 60 wt. %, such as at least 70 wt. %, such as at least 80 wt. %, such as at least 85 wt. %, such as at least 90 wt. %, such as at least 95 wt. %, such as at least 98 wt. %, such as at least 99 wt. % based on the weight of the calcium sulfate hemihydrate and the calcium sulfate dihydrate. Furthermore, the calcined gypsum may be anhydrite (e.g., AII, AIII), α-hemihydrate, β-hemihydrate, or a combination thereof.

In addition to the stucco, the gypsum slurry may also contain other cementitious materials. These cementitious materials may include calcium sulfate anhydrite, land plaster, cement, fly ash, or any combination thereof. When present, they may be utilized in an amount of 30 wt. % or less, such as 25 wt. % or less, such as 20 wt. % or less, such as 15 wt. % or less, such as 10 wt. % or less, such as 8 wt. % or less, such as 5 wt. % or less based on the total content of the cementitious material.

As indicated above, the gypsum slurry may also include water. Water may be employed for fluidity and also for rehydration of the gypsum to allow for setting. The amount of water utilized is not necessarily limited by the present invention.

The weight ratio of the water to the stucco may be 0.1 or more, such as 0.2 or more, such as 0.2 or more, such as 0.3 or more, such as 0.4 or more, such as 0.5 or more. The water to stucco weight ratio may be 4 or less, such as 3.5 or less, such as 3 or less, such as 2.5 or less, such as 2 or less, such as 1.7 or less, such as 1.5 or less, such as 1.4 or less, such as 1.3 or less, such as 1.2 or less, such as 1.1 or less, such as 1 or less, such as 0.9 or less, such as 0.85 or less, such as 0.8 or less, such as 0.75 or less, such as 0.7 or less, such as 0.6 or less, such as 0.5 or less, such as 0.4 or less, such as 0.35 or less, such as 0.3 or less, such as 0.25 or less, such as 0.2 or less.

In addition to the stucco and the water, the gypsum slurry may also include any other conventional additives as known in the art. In this regard, such additives are not necessarily limited by the present invention. For instance, the additives may include dispersants, foam or foaming agents including aqueous foam (e.g. sulfates), set accelerators (e.g., ball mill accelerator, land plaster, sulfate salts, etc.), set retarders, binders, biocides (such as bactericides and/or fungicides), adhesives, pH adjusters, thickeners (e.g., silica fume, Portland cement, fly ash, clay, celluloses, high molecular weight polymers, etc.), leveling agents, non-leveling agents, colorants, fire retardants or additives (e.g., silica, silicates, expandable materials such as vermiculite, perlite, etc.), water repellants (e.g., waxes, silicones, siloxanes, etc.), fillers (e.g., glass spheres, glass fibers), natural and synthetic fibers (e.g. cellulosic fibers, microfibrillated fibers, nanocellulosic fibers, etc.), acids (e.g., boric acid), secondary phosphates (e.g., condensed phosphates or orthophosphates including trimetaphosphates, polyphosphates, and/or cyclophosphates, etc.) and/or other phosphate derivatives (e.g., fluorophosphates, etc.), natural and synthetic polymers, starches (e.g., pregelatinized starch, non-pregelatinized starch, and/or a modified starch, such as an acid modified starch), sound dampening polymers (e.g., viscoelastic polymers/glues, such as those including an acrylic/acrylate polymer, etc.; polymers with low glass transition temperature, etc.), and mixtures thereof. In general, it should be understood that the types and amounts of such additives are not necessarily limited by the present invention.

Each additive of the gypsum slurry may be present in the gypsum slurry in an amount of 0.0001 wt. % or more, such as 0.001 wt. % or more, such as 0.01 wt. % or more, such as 0.02 wt. % or more, such as 0.05 wt. % or more, such as 0.1 wt. % or more, such as 0.15 wt. % or more, such as 0.2 wt. % or more, such as 0.25 wt. % or more, such as 0.3 wt. % or more, such as 0.5 wt. % or more, such as 1 wt. % or more, such as 2 wt. % or more. The additive may be present in an amount of 20 wt. % or less, such as 15 wt. % or less, 10 wt. % or less, such as 7 wt. % or less, such as 5 wt. % or less, such as 4 wt. % or less, such as 3 wt. % or less, such as 2.5 wt. % or less, such as 2 wt. % or less, such as 1.8 wt. % or less, such as 1.5 wt. % or less, such as 1 wt. % or less, such as 0.8 wt. % or less, such as 0.6 wt. % or less, such as 0.5 wt. % or less, such as 0.4 wt. % or less, such as 0.35 wt. % or less, such as 0.3 wt. % or less, such as 0.2 wt. % or less, such as 0.15 wt. % or less. The weight percentage may be based on the weight of the gypsum panel. Further, the weight percentage may be based on the weight of the gypsum core. In a further embodiment, such weight percentage may be based on the weight of a respective gypsum core layer. In an even further embodiment, the aforementioned weight percentages may be based on the solids content of the gypsum slurry. Moreover, the aforementioned weight percentages may be based on the weight of the stucco in the gypsum slurry. Additionally, the aforementioned weight percentages may be based on the weight of the gypsum in the gypsum core. In an additional embodiment, the aforementioned weight percentages may be based on the weight of the gypsum in the respective facing material. In yet another embodiment, the aforementioned weight percentages may be based on the weight of the gypsum in the respective gypsum core layer.

The foaming agent may be one generally utilized in the art. For instance, the foaming agent may include an alkyl sulfate, an alkyl ether sulfate, or a combination thereof. In one embodiment, the foaming agent includes an alkyl sulfate. In another embodiment, the foaming agent includes an alkyl ether sulfate. In a further embodiment, the foaming agent includes an alkyl sulfate without an alkyl ether sulfate. In an even further embodiment, the foaming agent includes a mixture of an alkyl sulfate and an alkyl ether sulfate. When a mixture is present, the alkyl ether sulfate may be present in an amount of 30 wt. % or less, such as 20 wt. % or less, such as 10 wt. % or less, such as 9 wt. % or less, such as 8 wt. % or less, such as 7 wt. % or less, such as 6 wt. % or less, such as 5 wt. % or less, such as 4 wt. % or less, such as 3 wt. % or less, such as 2 wt. % or less based on the combined weight of the alkyl sulfate and the alkyl ether sulfate. In addition, the alkyl ether sulfate may be present in an amount of 0.01 wt. % or more, such as 0.1 wt. % or more, such as 0.2 wt. % or more, such as 0.3 wt. % or more, such as 0.5 wt. % or more, such as 1 wt. % or more, such as 1.5 wt. % or more, such as 2 wt. % or more, such as 2.5 wt. % or more, such as 3 wt. % or more, such as 4 wt. % or more, such as 5 wt. % or more, such as 10 wt. % or more, such as 20 wt. % or more, based on the combined weight of the alkyl sulfate and the alkyl ether sulfate.

As indicated, the foaming agent may include a combination of an alkyl sulfate and an alkyl ether sulfate. In this regard, the weight ratio of the alkyl sulfate to the alkyl ether sulfate may be 2 or more, such as 4 or more, such as 5 or more, such as 10 or more, such as 15 or more, such as 20 or more, such as 25 or more, such as 30 or more, such as 40 or more, such as 50 or more, such as 60 or more, such as 70 or more, such as 80 or more, such as 90 or more, such as 95 or more. The weight ratio may be less than 100, such as 99 or less, such as 98 or less, such as 95 or less, such as 90 or less, such as 85 or less, such as 80 or less, such as 75 or less, such as 70 or less, such as 60 or less, such as 50 or less, such as 40 or less, such as 30 or less, such as 20 or less, such as 15 or less, such as 10 or less, such as 8 or less, such as 5 or less, such as 4 or less.

In another aspect, the alkyl ether sulfate may be present in the foaming agent in an amount of 100 wt. % or less, such as 90 wt. % or less, such as 80 wt. % or less, such as 70 wt. % or less, such as 60 wt. % or less, such as 50 wt. % or less, such as 40 wt. % or less, such as 30 wt. % or less, such as 20 wt. % or less, such as 10 wt. % or less, such as 5 wt. % or less. The alkyl ether sulfate may be present in the foaming agent in an amount of 0.01 wt. % or more, such as 5 wt. % or more, such as 10 wt. % or more, such as 20 wt. % or more, such as 30 wt. % or more, such as 40 wt. % or more, such as 50 wt. % or more, such as 60 wt. % or more, such as 70 wt. % or more, such as 80 wt. % or more, such as 90 wt. % or more.

Additionally, in one aspect, the alkyl sulfate may be present in the foaming agent in an amount of 100 wt. % or less, such as 90 wt. % or less, such as 80 wt. % or less, such as 70 wt. % or less, such as 60 wt. % or less, such as 50 wt. % or less, such as 40 wt. % or less, such as 30 wt. % or less, such as 20 wt. % or less, such as 10 wt. % or less, such as 5 wt. % or less. The alkyl sulfate may be present in the foaming agent in an amount of 0.01 wt. % or more, such as 5 wt. % or more, such as 10 wt. % or more, such as 20 wt. % or more, such as 30 wt. % or more, such as 40 wt. % or more, such as 50 wt. % or more, such as 60 wt. % or more, such as 70 wt. % or more, such as 80 wt. % or more, such as 90 wt. % or more.

By utilizing a soap, foaming agent, and/or foam as disclosed herein, the gypsum slurry may include bubbles or voids having a particular size. Such size may then contribute to the void structure in the gypsum panel and the resulting properties. In this regard, the gypsum slurry may have bubbles or voids having a median size of 90 microns or more, such as 100 microns or more, such as 200 microns or more, such as 300 microns or more, such as 400 microns or more, such as 500 microns or more, such as 600 microns or more, such as 700 microns or more, such as 800 microns or more, such as 900 microns or more, such as 1,000 microns or more. The gypsum slurry may have bubbles or voids having a median size of 1,400 microns or less, such as 1,300 microns or less, such as 1,200 microns or less, such as 1,100 microns or less, such as 1,000 microns or less, such as 900 microns or less, such as 800 microns or less, such as 700 microns or less, such as 600 microns or less, such as 500 microns or less, such as 400 microns or less, such as 300 microns or less, such as 200 microns or less, such as 100 microns or less. Furthermore, while the aforementioned references a median size, it should be understood that in another embodiment, such size may also refer to an average size.

In one aspect, the foam may be provided in an amount of 75 lbs/MSF or more, such as 100 lbs/MSF or more, such as 125 lbs/MSF or more, such as 150 lbs/MSF or more, such as 175 lbs/MSF or more, such as 200 lbs/MSF or more, such as 225 lbs/MSF or more, such as 250 lbs/MSF or more, such as 275 lbs/MSF or more, such as 300 lbs/MSF or more, such as 325 lbs/MSF or more. The foam may be provided in an amount of 350 lbs/MSF or less, such as 325 lbs/MSF or less, such as 300 lbs/MSF or less, such as 275 lbs/MSF or less, such as 250 lbs/MSF or less, such as 225 lbs/MSF or less, such as 200 lbs/MSF or less, such as 175 lbs/MSF or less, such as 150 lbs/MSF or less, such as 125 lbs/MSF or less, such as 100 lbs/MSF or less.

The foam may comprise water and a foaming agent. In one aspect, the foaming agent may be provided in an amount of 0.05 lbs/MSF or more, such as 0.25 lbs/MSF or more, such as 0.5 lbs/MSF or more, such as 0.75 lbs/MSF or more, such as 1 lb/MSF or more, such as 2 lbs/MSF or more, such as 3 lbs/MSF or more, such as 4 lbs/MSF or more. The foaming agent may be provided in an amount of 5 lbs/MSF or less, such as 4 lbs/MSF or less, such as 3 lbs/MSF or less, such as 2 lbs/MSF or less, such as 1 lb/MSF or less, such as 0.5 lbs/MSF or less, such as 0.25 lbs/MSF or less. Further, in one aspect, the water utilized in the foam may be provided in an amount of 70 lbs/MSF or more, such as 75 lbs/MSF or more, such as 100 lbs/MSF or more, such as 125 lbs/MSF or more, such as 150 lbs/MSF or more, such as 175 lbs/MSF or more, such as 200 lbs/MSF or more, such as 225 lbs/MSF or more, such as 250 lbs/MSF or more, such as 275 lbs/MSF or more, such as 300 lbs/MSF or more, such as 325 lbs/MSF or more. The water utilized in the foam may be provided in an amount of 350 lbs/MSF or less, such as 325 lbs/MSF or less, such as 300 lbs/MSF or less, such as 275 lbs/MSF or less, such as 250 lbs/MSF or less, such as 225 lbs/MSF or less, such as 200 lbs/MSF or less, such as 175 lbs/MSF or less, such as 150 lbs/MSF or less, such as 125 lbs/MSF or less, such as 100 lbs/MSF or less.

In one aspect, the foaming agent may be provided in an amount of 0.5 lbs/ft³ or more, such as 1 lb/ft³ or more, such as 1.5 lbs/ft³ or more, such as 2 lbs/ft³ or more, such as 2.5 lbs/ft³ or more, such as 3 lbs/ft³ or more, such as 3.5 lbs/ft³ or more, such as 4 lbs/ft³ or more, such as 4.5 lbs/ft³ or more, such as 5 lbs/ft³ or more. The foaming agent may be provided in an amount of 25 lbs/ft³ or less, such as 20 lbs/ft³ or less, such as 15 lbs/ft³ or less, such as 13 lbs/ft³ or less, such as 11 lbs/ft³ or less, such as 10 lbs/ft³ or less, such as 9 lbs/ft³ or less, such as 8 lbs/ft³ or less, such as 7 lbs/ft³ or less, such as 6 lbs/ft³ or less.

As indicated above, the additives may include at least one dispersant. The dispersant is not necessarily limited and may include any that can be utilized within the gypsum slurry. The dispersant may include carboxylates, sulfates, sulfonates, phosphates, mixtures thereof, etc. For instance, in one embodiment, the dispersant may include a sulfonate.

In another embodiment, the dispersant may include a carboxylate, such as a carboxylate ether and in particular a polycarboxylate ether or a carboxylate ester and in particular a polycarboxylate ester.

In a further embodiment, the dispersant may include a sulfonate, such as a naphthalene sulfonate, a naphthalene sulfonate formaldehyde condensate, a sodium naphthalene sulfonate formaldehyde condensate, a lignosulfonate, a melamine formaldehyde condensate, or a combination thereof.

In another embodiment, the dispersant may include a phosphate. For instance, the phosphate dispersant may be a polyphosphate dispersant, such as sodium trimetaphosphate, sodium tripolyphosphate, potassium tripolyphosphate, tetrasodium pyrophosphate, tetrapotassium pyrophosphate, tetrapotassium pyrophosphate, or a combination thereof. In one embodiment, the polyphosphate dispersant may be sodium trimetaphosphate.

In this regard, the dispersant may include a sulfonate, a polycarboxylate ether, a polycarboxylate ester, or a combination thereof. In one embodiment, the dispersant may include a sulfonate. In another embodiment, the dispersant may include a polycarboxylate ether. In a further embodiment, the dispersant may include a polycarboxylate ester.

In one aspect, the dispersant may be provided in an amount of 0.01 lbs/MSF or more, such as 0.5 lbs/MSF or more, such as 1 lb/MSF or more, such as 2 lbs/MSF or more, such as 5 lbs/MSF or more, such as 8 lbs/MSF or more, such as 10 lbs/MSF or more, such as 15 lbs/MSF or more, such as 20 lbs/MSF or more, such as 25 lbs/MSF or more, such as 30 lbs/MSF or more, such as 35 lbs/MSF or more. The dispersant may be provided in an amount of 40 lbs/MSF or less, such as 35 lbs/MSF or less, such as 30 lbs/MSF or less, such as 25 lbs/MSF or less, such as 20 lbs/MSF or less, such as 15 lbs/MSF or less, such as 10 lbs/MSF or less, such as 8 lbs/MSF or less, such as 5 lbs/MSF or less, such as 2 lbs/MSF or less, such as 1 lb/MSF or less.

In one aspect, the dispersant may be provided in an amount of 0.5 lbs/ft³ or more, such as 1 lb/ft³ or more, such as 1.5 lbs/ft³ or more, such as 2 lbs/ft³ or more, such as 2.5 lbs/ft³ or more, such as 3 lbs/ft³ or more, such as 3.5 lbs/ft³ or more, such as 4 lbs/ft³ or more, such as 4.5 lbs/ft³ or more, such as 5 lbs/ft³ or more. The dispersant may be provided in an amount of 25 lbs/ft³ or less, such as 20 lbs/ft³ or less, such as 15 lbs/ft³ or less, such as 13 lbs/ft³ or less, such as 11 lbs/ft³ or less, such as 10 lbs/ft³ or less, such as 9 lbs/ft³ or less, such as 8 lbs/ft³ or less, such as 7 lbs/ft³ or less, such as 6 lbs/ft³ or less.

As indicated above, the additives may include a starch. The starch may be one generally utilized in the art. Such starch may be combined with the stucco and water. In this regard, such starch may be present in the gypsum slurry as well as the resulting gypsum core and gypsum panel.

The starch may be a corn starch, a wheat starch, a milo starch, a potato starch, a rice starch, an oat starch, a barley starch, a cassava starch, a tapioca starch, a pea starch, a rye starch, an amaranth starch, or other commercially available starch. For example, in one embodiment, the starch may be a corn starch. In another embodiment, the starch may be a wheat starch. In an even further embodiment, the starch may be a milo starch.

Furthermore, the starch may be an unmodified starch or a modified starch. In one embodiment, the starch may be a modified starch. In another embodiment, the starch may be an unmodified starch. In an even further embodiment, the starch may be a mixture of a modified starch and an unmodified starch.

As indicated above, in one embodiment, the starch may be an unmodified starch. For instance, the starch may be a pearl starch (e.g., an unmodified corn starch). In addition, in one embodiment, the starch may also be a non-migrating starch. Also, with respect to gelatinization, the starch may be a non-pregelatinized starch.

As also indicated above, in another embodiment, the starch may be a modified starch. Such modification may be any as typically known in the art and is not necessarily limited. For instance, the modification may be via a physical, enzymatic, or chemical treatment. In one embodiment, the modification may be via a physical treatment. In another embodiment, the modification may be via an enzymatic treatment. In a further embodiment, the modification may be via a chemical treatment. The starch may be treated using many types of reagents. For example, the modification can be conducted using various chemicals, such as inorganic acids (e.g., hydrochloric acid, phosphorous acid or salts thereof, etc.), peroxides (e.g., sodium peroxide, potassium peroxide, hydrogen peroxide, etc.), anhydrides (e.g., acetic anhydride), etc. to break down the starch molecule.

In this regard, in one embodiment, the starch may be a pregelatinized starch, an acid-modified (or hydrolyzed) starch, an extruded starch, an oxidized starch, an oxyhydrolyzed starch, an ethoxylated starch, an ethylated starch, an acetylated starch, a combination thereof, etc. For example, in one embodiment, the starch may be a pregelatinized starch. In another embodiment, the starch may be an acid-modified (or hydrolyzed) starch. In a further embodiment, the starch may be an extruded starch. In another embodiment, the starch may be an oxidized starch. In a further embodiment, the starch may be an oxyhydrolyzed starch. In another further embodiment, the starch may be an ethoxylated starch. In another embodiment, the starch may be an ethylated starch. In a further embodiment, the starch may be an acetylated starch.

In one embodiment, the starch may be a pregelatinized starch. In this regard, the starch may have been exposed to water and heat for breaking down a certain degree of intermolecular bonds within the starch. As an example and without intending to be limited by theory, during heating, water is absorbed into the amorphous regions of the starch thereby allowing it to swell. Then amylose chains may begin to dissolve resulting in a decrease in the crystallinity and an increase in the amorphous form of the starch.

In another embodiment, the starch may be an acid-modified starch. Such acid modification can be conducted using various chemicals, such as inorganic acids (e.g., hydrochloric acid, phosphorous acid or salts thereof, etc.) to break down the starch molecule. Furthermore, by utilizing acid-modification, the starch may result in a low thinned starch, a medium thinned starch, or a high thinned starch. For example, a higher degree of modification can result in a lower viscosity starch while a lower degree of modification can result in a higher viscosity starch. The degree of modification and resulting viscosity may also affect the degree of migration of the starch. For instance, when presented within the core of the gypsum panel, a higher degree of modification and lower viscosity may provide a high migrating starch while a lower degree of modification and higher viscosity may provide a low migrating starch.

The starch may also have a particular gelling temperature. Without intending to be limited, this temperature is the point at which the intermolecular bonds of the starch are broken down in the presence of water and heat allowing the hydrogen bonding sites to engage more water. In this regard, the gelling temperature may be 60° C. or more, such as 80° C. or more, such as 100° C. or more. The gelling temperature may be 120° C. or less, such as 100° C. or less, such as 80° C. or less. In one embodiment, the aforementioned may refer to a peak gelling temperature.

As indicated above, the starch may have a particular gelling temperature. Without intending to be limited by theory, acid modification may provide a starch having a relatively lower gelling temperature. Meanwhile, without intending to be limited by theory, modifications of the hydroxyl group, such as by replacement via ethoxylation, ethylation, or acetylation may provide a relatively lower gelling temperature or a reduction in gelling temperature. In this regard, in some embodiments, the starch may be acid-modified and chemically modified wherein the hydroxyl groups are substituted.

In one embodiment, the starch may be an extruded starch. For example, the extrusion may provide a thermomechanical process that can break the intermolecular bonds of the starch. Such extrusion may result in the gelatinization of starch due to an increase in the water absorption.

In another embodiment, the starch may be an oxidized starch. For example, the starch may be oxidized using various means known in the art. This may include, but is not limited to, chemical treatments utilizing oxidizing agents such as chlorites, chlorates, perchlorates, hypochlorites (e.g., sodium hypochlorite, etc.), peroxides (e.g., sodium peroxide, potassium peroxide, hydrogen peroxide, etc.), etc. In general, during oxidation, the molecules are broken down yielding a starch with a decreased molecular weight and a reduction in viscosity.

Also, it should be understood that the starch may include a combination of starches, such as any of those mentioned above. For instance, it should be understood that the starch may include more than one different starch. In addition, any combination of modifications may also be utilized to form the starch utilized according to the present invention.

In one aspect, the starch may be provided in an amount of 0.001 lbs/MSF or more, such as 0.01 lbs/MSF or more, such as 0.05 lbs/MSF or more, such as 0.1 lbs/MSF or more, such as 0.2 lbs/MSF or more, such as 0.25 lbs/MSF or more, such as 0.5 lbs/MSF or more, such as 0.75 lbs/MSF or more, such as 1 lb/MSF or more, such as 1.5 lbs/MSF or more, such as 2 lbs/MSF or more, such as 2.5 lbs/MSF or more, such as 3 lbs/MSF or more, such as 4 lbs/MSF or more, such as 5 lbs/MSF or more, such as 8 lbs/MSF or more, such as 10 lbs/MSF or more, such as 15 lbs/MSF or more, such as 20 lbs/MSF or more. The starch may be present in an amount of 50 lbs/MSF or less, such as 30 lbs/MSF or less, such as 25 lbs/MSF or less, such as 20 lbs/MSF or less, such as 15 lbs/MSF or less, such as 10 lbs/MSF or less, such as 5 lbs/MSF or less, such as 4 lbs/MSF or less, such as 3 lbs/MSF or less, such as 2.5 lbs/MSF or less, such as 2 lbs/MSF or less, such as 1.5 lbs/MSF or less, such as 1 lb/MSF or less.

In general, the present invention is also directed to a method of making a gypsum panel. For instance, in the method of making a gypsum panel, a first facing material may be provided wherein the first facing material has a first facing material surface and a second facing material surface opposite the first facing material surface. The first facing material may be conveyed on a conveyor system (i.e., a continuous system for continuous manufacture of gypsum panel). Thereafter, a gypsum slurry may be provided or deposited onto the first facing material in order to form and provide a gypsum core. Next, a second facing material may be provided onto the gypsum slurry. The first facing material, the gypsum core, and the second facing material may then be dried simultaneously. Next, the first facing material, the gypsum core, and the second facing material may be cut such that the first facing material, the gypsum core, and the second facing material form a gypsum panel.

The manner in which the components (e.g., stucco, water) for the gypsum slurry are combined is not necessarily limited. For instance, the gypsum slurry can be made using any method or device generally known in the art. In particular, the components of the slurry can be mixed or combined using any method or device generally known in the art. For instance, the components of the gypsum slurry may be combined in any type of device, such as a mixer and in particular a pin mixer. In this regard, the manner in which the components are incorporated into the gypsum slurry is not necessarily limited by the present invention. Such components may be provided prior to a mixing device, directly into a mixing device, in a separate mixing device, and/or even after the mixing device. For instance, the respective components may be provided prior to a mixing device. In another embodiment, the respective components may be provided directly into a mixing device. For instance, in one embodiment, the foaming agent or soap may be provided directly into the mixer. Alternatively, the respective components may be provided after the mixing device (such as to the canister or boot, using a secondary mixer, or applied directly onto the slurry after a mixing device) and may be added directly or as part of a mixture. Whether provided prior to, into, or after the mixing device, the components may be combined directly with another component of the gypsum slurry. In addition, whether providing the components prior to or after the mixing device or directly into the mixing device, the compound may be delivered as a solid, as a dispersion/solution, or a combination thereof.

Upon deposition of the gypsum slurry, the calcium sulfate hemihydrate reacts with the water to hydrate the calcium sulfate hemihydrate into a matrix of calcium sulfate dihydrate. Such reaction may allow for the gypsum to set and become firm thereby allowing for the panels to be cut at the desired length. In this regard, the method may comprise a step of reacting calcium sulfate hemihydrate with water to form calcium sulfate dihydrate or allowing the calcium sulfate hemihydrate to hydrate or convert to calcium sulfate dihydrate. In this regard, the method may allow for the slurry to set to form a gypsum panel. In addition, during this process, the method may allow for drying of the gypsum slurry, in particular drying any free water instead of combined water of the gypsum slurry. Such drying may occur prior to the removal of any free moisture or water in a heating or drying device after a cutting step. Thereafter, the method may also comprise a step of cutting a continuous gypsum sheet into a gypsum panel. Then, after the cutting step, the method may comprise a step of supplying the gypsum panel to a heating or drying device to undergo a drying process. For instance, such a heating or drying device may be a kiln and may allow for removal of any free water. The temperature and time required for drying in a heating device is not necessarily limited by the present invention.

In one aspect, the method of making a gypsum panel may comprise applying a coating as disclosed herein to a facing material. The coating may be provided on the surface of the facing material (e.g., first facing material, second facing material) that is opposite the surface adjacent to the gypsum slurry or gypsum core. Thereafter, the slurry and core may set, the panel may be dried, and the panel may be cut or sliced using standard techniques as known in the art.

In the aforementioned, the coating may be provided to the facing material prior to the steps as disclosed above. In this regard, the facing material may be pre-coated. That is, the facing material may be pre-coated off-line (i.e., in a different manufacturing line) and dried. The facing material may then be optionally rolled and placed in-line for the providing step mentioned above. Alternatively, the facing material may be provided in-line and coated in-line prior to the providing step mentioned above.

In another embodiment, the coating may be provided to the facing material after the providing step as disclosed above. For instance, once the facing material is provided to the manufacturing process and the slurry, such as the gypsum slurry, is sandwiched, the coating formulation may be applied as disclosed herein in order to provide the coating on the facing material.

In one embodiment, the gypsum core may include a first gypsum core layer and a second gypsum core layer. The first gypsum core layer may be between the first facing material (e.g., front of the gypsum panel) and the second gypsum core layer. In addition, the first gypsum core layer may have a density greater than the second gypsum core layer. Accordingly, the first gypsum core layer may be formed using a gypsum slurry without the use of foam and/or a foaming agent or with a reduced amount of foam and/or a foaming agent, which may be utilized in forming the second gypsum core layer. In this regard, in one embodiment, the first gypsum core layer may have the same composition as the second gypsum core layer except that the second gypsum core layer may be formed using foam and/or a foaming agent or a greater amount of foam and/or a foaming agent.

In one embodiment, the gypsum core may also include a third gypsum core layer. The third gypsum core layer may be provided between the second gypsum core layer and a second facing material (e.g., back of the gypsum panel). Like the first gypsum core layer, the third gypsum core layer may also be a dense gypsum core layer. In particular, the third gypsum core layer may have a density greater than the second gypsum core layer. Accordingly, the third gypsum core layer may be formed using a gypsum slurry without the use of foam and/or a foaming agent or with a reduced amount of foam and/or a foaming agent, which may be utilized in forming the second gypsum core layer. In this regard, in one embodiment, the third gypsum core layer may have the same composition as the second gypsum core layer except that the second gypsum core layer may be formed using foam and/or a foaming agent or a greater amount of foam and/or a foaming agent.

When the gypsum core includes multiple gypsum core layers, the gypsum slurry may be deposited in multiple steps for forming the gypsum core. For instance, each gypsum core layer may require a separate deposition of gypsum slurry. In this regard, with a first gypsum core layer and a second gypsum core layer, a first gypsum slurry may be deposited followed by a second gypsum slurry. The first gypsum slurry and the second gypsum slurry may have the same composition except that the second gypsum slurry may include foam and/or a foaming agent or more foam and/or a foaming agent than the first gypsum slurry. In this regard, in one embodiment, the first gypsum slurry may not include foam and/or a foaming agent. Accordingly, the first gypsum slurry may result in a dense gypsum core layer, in particular a non-foamed gypsum core layer. Such gypsum core layer may have a density greater than the gypsum core layer formed from the second gypsum slurry, or foamed gypsum core layer.

Similarly, when the gypsum core includes three gypsum core layers, the gypsum slurry may be deposited in three steps for forming the gypsum core. For example, a first and second gypsum slurry may be deposited as indicated above and a third gypsum slurry may be deposited onto the second gypsum slurry. The third gypsum slurry and the second gypsum slurry may have the same composition except that the second gypsum slurry may include foam and/or a foaming agent or more foam and/or a foaming agent than the third gypsum slurry. In this regard, in one embodiment, the third gypsum slurry may not include foam and/or a foaming agent. Accordingly, the third gypsum slurry may result in a dense gypsum core layer, in particular a non-foamed gypsum core layer. Such gypsum core layer may have a density greater than the gypsum core layer formed from the second gypsum slurry, or foamed gypsum core layer.

The first gypsum core layer may have a thickness that is 0.5% or more, such as 1% or more, such as 2% or more, such as 3% or more, such as 4% or more, such as 5% or more, such as 10% or more, such as 15% or more than the thickness of the second (or foamed) gypsum core layer. The thickness may be 80% or less, such as 60% or less, such as 50% or less, such as 40% or less, such as 30% or less, such as 25% or less, such as 20% or less, such as 15% or less, such as 10% or less, such as 8% or less, such as 5% or less the thickness of the second (or foamed) gypsum core layer. In one embodiment, such relationship may also be between the third gypsum core layer and the second gypsum core layer.

The density of the second (or foamed) gypsum core layer may be 0.5% or more, such as 1% or more, such as 2% or more, such as 3% or more, such as 4% or more, such as 5% or more, such as 10% or more, such as 15% or more the density of the first (or non-foamed) gypsum core layer. The density of the second (or foamed) gypsum core layer may be 80% or less, such as 60% or less, such as 50% or less, such as 40% or less, such as 30% or less, such as 25% or less, such as 20% or less, such as 15% or less, such as 10% or less, such as 8% or less, such as 5% or less the density of the first (or non-foamed) gypsum core layer. In one embodiment, such relationship may also be between the third gypsum core layer and the second gypsum core layer. In addition, in one embodiment, all of the gypsum core layers may have a different density.

Generally, the first gypsum core layer, the second gypsum core layer, and/or the third gypsum core layer may contain any of the additives as disclosed herein. Further, the first gypsum core layer, the second gypsum core layer, and/or the third gypsum core layer may contain an additive in an amount as previously indicated herein.

In one embodiment, the gypsum panel may be processed such that any respective gypsum core layer may have an average void size of about 90 microns to about 1200 microns, such as about 90 microns or more, such as about 100 microns or more, such as about 150 microns or more, such as about 200 microns or more, such as about 250 microns or more, such as about 300 microns or more, such as about 350 microns or more, such as about 400 microns or more, such as about 450 microns or more, such as about 500 microns or more, such as about 600 microns or more, such as about 700 microns or more, such as about 800 microns or more. Generally, the average void size may be about 1200 microns or less, such as about 1100 microns or less, such as about 1000 microns or less, such as about 900 microns or less, such as about 800 microns or less, such as about 700 microns or less, such as about 600 microns or less, such as about 500 microns or less, such as about 400 microns or less, such as about 300 microns or less, such as about 200 microns or less, such as about 100 microns or less. In one embodiment, such core voids may reference any air voids due to voids generated from the use of a soap/foam. Furthermore, while the aforementioned references an average void size, it should be understood that in another embodiment, such size may also refer to a median void size.

The specific surface area of the gypsum core is not necessarily limited and may be from about 0.25 m²/g to about 15 m²/g. For instance, the specific surface area may be 0.25 m²/g or more, such as 0.5 m²/g or more, such as 1 m²/g or more, such as 1.5 m²/g or more, such as 2 m²/g or more, such as 2.5 m²/g or more, such as 3 m²/g or more, such as 3.5 m²/g or more, such as 4 m²/g or more, such as 5 m²/g or more, such as 6 m²/g or more, such as 8 m²/g or more, such as 10 m²/g or more. The specific surface area of the gypsum core may be 15 m²/g or less, such as 10 m²/g or less, such as 8 m²/g or less, such as 6 m²/g or less, such as 4 m²/g or less, such as 3.5 m²/g or less, such as 3 m²/g or less, such as 2.5 m²/g or less, such as 2 m²/g or less, such as 1.5 m²/g or less, such as 1 m²/g or less.

The thickness of the gypsum panel, and in particular, the gypsum core, is not necessarily limited and may be from about 0.25 inches to about 1 inch. For instance, the thickness may be at least ¼ inches, such as at least 5/16 inches, such as at least ⅜ inches, such as at least ½ inches, such as at least ⅝ inches, such as at least ¾ inches, such as at least 1 inch. In this regard, the thickness may be about any one of the aforementioned values. For instance, the thickness may be about ¼ inches. Alternatively, the thickness may be about ⅜ inches. In another embodiment, the thickness may be about ½ inches. In a further embodiment, the thickness may be about ⅝ inches. In another further embodiment, thickness may be about 1 inch. In addition, at least two gypsum panels may be combined to create another gypsum panel, such as a composite gypsum panel. For example, at least two gypsum panels having a thickness of about 5/16 inches each may be combined or sandwiched to create a gypsum panel having a thickness of about ⅝ inches. While this is one example, it should be understood that any combination of gypsum panels may be utilized to prepare a sandwiched gypsum panel. With regard to the thickness, the term “about” may be defined as within 10%, such as within 5%, such as within 4%, such as within 3%, such as within 2%, such as within 1%. However, it should be understood that the present invention is not necessarily limited by the aforementioned thicknesses.

In addition, the gypsum panel may have a density of about 15 pcf or more, such as about 20 pcf or more, such as about 25 pcf or more, such as about 28 pcf or more, such as about 30 pcf or more, such as about 33 pcf or more, such as about 35 pcf or more, such as about 38 pcf or more, such as about 40 pcf or more, such as about 43 pcf or more, such as about 45 pcf or more, such as about 48 pcf or more, such as about 50 pcf or more, such as about 55 pcf or more, such as about 60 pcf or more, such as about 65 pcf or more. The gypsum panel may have a density of about 80 pcf or less, such as about 75 pcf or less, such as about 70 pcf or less, such as about 65 pcf or less, such as about 60 pcf or less, such as about 55 pcf or less, such as about 50 pcf or less, such as about 40 pcf or less, such as about 35 pcf or less, such as about 33 pcf or less, such as about 30 pcf or less, such as about 28 pcf or less, such as about 25 pcf or less, such as about 23 pcf or less, such as about 20 pcf or less, such as about 18 pcf or less. It should be understood that a cement panel may have any of the aforementioned densities. For instance, a cement panel may have a density from about 15 pcf to about 80 pcf, including all increments of 1 pcf therebetween.

The gypsum panel may have a certain nail pull resistance (i.e., nail pull strength), which generally is a measure of the force required to pull a gypsum panel off a wall by forcing a fastening nail through the panel. The values obtained from the nail pull test generally indicate the maximum stress achieved while the fastener head penetrates through the panel surface and core. In this regard, the gypsum panel exhibits a nail pull resistance of at least about 25 lbt, such as at least about 30 pounds, such as at least about 35 lbt, such as at least about 40 lbt, such as at least about 45 lbt, such as at least about 50 lbt, such as at least about 55 lbt, such as at least about 60 lbt, such as at least about 65 lbt, such as at least about 70 lbt, such as at least about 75 lbt, such as at least about 77 lbt, such as at least about 80 lbt, such as at least about 85 lbt, such as at least about 90 lbt, such as at least about 95 lbt, such as at least about 100 lbt as tested according to ASTM C1396-17. The nail pull resistance may be about 400 lbt or less, such as about 300 lbt or less, such as about 200 lbt or less, such as about 150 lbt or less, such as about 140 lbt or less, such as about 130 lbt or less, such as about 120 lbt or less, such as about 110 lbt or less, such as about 105 lbt or less, such as about 100 lbt or less, such as about 95 lbt or less, such as about 90 lbt or less, such as about 85 lbt or less, such as about 80 lbt or less as tested according to ASTM C1396-17. Such nail pull resistance may be based upon the thickness of the gypsum panel. For instance, when conducting a test, such nail pull resistance values may vary depending on the thickness of the gypsum panel. As an example, the nail pull resistance values above may be for a ⅝ inch panel. However, it should be understood that instead of a ⅝ inch panel, such nail pull resistance values may be for any other thickness gypsum panel as mentioned herein.

The gypsum panel may have a certain compressive strength. For instance, the compressive strength may be about 150 psi or more, such as about 200 psi or more, such as about 250 psi or more, such as about 300 psi or more, such as about 350 psi or more, such as about 375 psi or more, such as about 400 psi or more, such as about 600 psi or more, such as about 800 psi or more, such as about 1000 psi or more as tested according to ASTM C473-19. The compressive strength may be about 3000 psi or less, such as about 2500 psi or less, such as about 2000 psi or less, such as about 1700 psi or less, such as about 1500 psi or less, such as about 1300 psi or less, such as about 1100 psi or less, such as about 1000 psi or less, such as about 900 psi or less, such as about 800 psi or less, such as about 700 psi or less, such as about 600 psi or less, such as about 500 psi or less. Such compressive strength may be based upon the density and thickness of the gypsum panel. For instance, when conducting a test, such compressive strength values may vary depending on the thickness of the gypsum panel. As an example, the compressive strength values above may be for a ⅝ inch panel. However, it should be understood that instead of a ⅝ inch panel, such compressive strength values may be for any other thickness gypsum panel as mentioned herein.

In general, the Z-tensile strength is indicative of the force required to remove the gypsum panel from an adhered surface and may also provide an indication of the bleed-through of gypsum through the facing material, such as the glass mat facing material. In this regard, the Z-tensile strength, as determined in accordance with ASTM C297 as disclosed herein, may be 30 lbf or more, such as 35 lbf or more, such as 40 lbf or more, such as 45 lbf or more, such as 50 lbf or more, such as 55 lbf or more, such as 60 lbf or more, such as 65 lbf or more, such as 70 lbf or more, such as 75 lbf or more, such as 80 lbf or more, such as 85 lbf or more. The Z-tensile strength may be 150 lbf or less, such as 140 lbf or less, such as 130 lbf or less, such as 120 lbf or less, such as 110 lbf or less, such as 100 lbf or less, such as 90 lbf or less, such as 85 lbf or less, such as 80 lbf or less, such as 75 lbf or less, such as 70 lbf or less, such as 65 lbf or less, such as 60 lbf or less.

Generally, the gypsum panel may have a pull through strength of about 300 lbf or more, such as about 325 lbf or more, such as about 350 lbf or more, such as about 375 lbf or more, such as about 400 lbf or more as determined in accordance with ANSI/SPRI/FM BPT-12021.

In addition, the gypsum panel may have a core hardness of at least about 8 lbt, such as at least about 10 lbt, such as at least about 11 lbt, such as at least about 12 lbt, such as at least about 15 lbt, such as at least about 18 lbt, such as at least about 20 lbt as tested according to ASTM C1396-17. The gypsum panel may have a core hardness of 50 lbt or less, such as about 40 lbt or less, such as about 35 lbt or less, such as about 30 lbt or less, such as about 25 lbt or less, such as about 20 lbt or less, such as about 18 lbt or less, such as about 15 lbt or less as tested according to ASTM C1396-17. In addition, the gypsum panel may have an end hardness according to the aforementioned values. Such core hardness may be based upon the thickness of the gypsum panel. For instance, when conducting a test, such core hardness values may vary depending on the thickness of the gypsum panel. As an example, the core hardness values above may be for a ⅝ inch panel. However, it should be understood that instead of a ⅝ inch panel, such core hardness values may be for any other thickness gypsum panel as mentioned herein.

In addition, the gypsum panel may have an edge hardness of at least about 8 lbt, such as at least about 10 lbt, such as at least about 11 lbt, such as at least about 12 lbt, such as at least about 15 lbt, such as at least about 18 lbt, such as at least about 20 lbt, such as at least about 24 lbt, such as at least about 28 lbt, such as at least about 30 lbt, such as at least about 33 lbt as tested according to ASTM C1396-17 and ASTM C473-19. The gypsum panel may have an edge hardness of about 50 lbt or less, such as about 40 lbt or less, such as about 35 lbt or less, such as about 30 lbt or less, such as about 25 lbt or less, such as about 20 lbt or less, such as about 18 lbt or less, such as about 15 lbt or less as tested according to ASTM C1396-17 and ASTM C473-19. Such edge hardness may be based upon the thickness of the gypsum panel. For instance, when conducting a test, such edge hardness values may vary depending on the thickness of the gypsum panel. As an example, the edge hardness values above may be for a ⅝ inch panel. However, it should be understood that instead of a ⅝ inch panel, such edge hardness values may be for any other thickness gypsum panel as mentioned herein.

In addition, as previously disclosed, it may also be desired to have an effective bond between the facing material and the gypsum core. Typically, a humidified bond test is performed for 2 hours in a humidity chamber at 90° F. and 90% humidity. In this test, after exposure, the facing material is removed to determine how much remains on the gypsum panel. The percent coverage (or surface area) can be determined using various optical analytical techniques. In this regard, the facing material may cover 100% or less, such as less than 90%, such as less than 80%, such as less than 70%, such as less than 60%, such as less than 50%, such as less than 40%, such as less than 30%, such as less than 25%, such as less than 20%, such as less than 15%, such as less than 10%, such as less than 9%, such as less than 8% of the surface area of the gypsum core upon conducting the test. Such percentage may be for a face of the gypsum panel. Alternatively, such percentage may be for a back of the gypsum panel. Further, such percentages may apply to the face and the back of the gypsum panel. In addition, such values may be for an average of at least 3 gypsum panels, such as at least 5 gypsum panels.

Also, it may be desired to have a particular humidified deflection based on exposure in an atmosphere of 90° F.±3° F. and 90%±3% relative humidity for 48 hours. For instance, the humidified deflection may be 0.1 inches or less, such as 0.08 inches or less, such as 0.06 inches or less, such as 0.05 inches or less, such as 0.04 inches or less, such as 0.03 inches or less, such as 0.02 inches or less, such as 0.01 inches or less, such as 0.005 inches or less. The humified deflection may be 0 inches or more, such as 0.0001 inches or more, such as 0.0005 inches or more, such as 0.001 inches or more, such as 0.003 inches or more, such as 0.005 inches or more, such as 0.008 inches or more, such as 0.01 inches or more, such as 0.015 inches or more. Such values may be for an average of at least 3 gypsum panels.

As previously disclosed herein, in one aspect, the panel may be a cement panel. The cement panel may comprise a cement core. The cement core may comprise one or more cement core binders. In general, a cement core binder includes a material which is able to set on hydration. Such materials may also be generally referred to as a hydraulic cement. The present invention is not necessarily limited and may include cement core binders generally known in the art. For instance, these may include, but are not limited to, a cement, a pozzolan material, gypsum, or a mixture thereof.

The cement may include any cement as generally known in the art. For instance, the cement may include, but is not limited to, Portland cement, magnesia cement, alumina cement (e.g., calcium aluminate cement), calcium sulphoaluminate cement, or a mixture thereof. In one embodiment, the cement may include at least Portland cement. In another embodiment, the cement may include at least alumina cement. In one embodiment, the cement core binder includes at least two, such as at least three the cements. For example, in one embodiment, the cement core binder may include at least Portland cement and an alumina cement.

The pozzolan material may include any pozzolan material as generally known in the art. For instance, the pozzolan material may include, but is not limited to, fly ash, blast furnace slag, metakaolin, silica fume, microsilica, or a mixture thereof. In one embodiment, the pozzolan material may include fly ash. In another embodiment, the pozzolan material may include blast furnace slag. In a further embodiment, the pozzolan material may include metakaolin. In another further embodiment, the pozzolan material may include silica fume. In an even further embodiment, the pozzolan material may include microsilica. In one embodiment, the cement core binder includes at least two, such as at least three pozzolan materials.

In general, the cement core binder may also include gypsum. When in the core, it may be present as uncalcined gypsum (i.e., calcium sulfate dihydrate). When added to the slurry, it may be added as calcined gypsum (i.e., calcium sulfate hemihydrate). Regardless, when utilized, it may be utilized in generally lower amounts. For example, the gypsum may be present in the core in an amount of 20 wt. % or less, such as 15 wt. % or less, such as 10 wt. % or less, such as 8 wt. % or less, such as 5 wt. % or less, such as 4 wt. % or less, such as 3 wt. % or less, such as 2 wt. % or less, such as 1 wt. % or less, such as 0.5 wt. % or less based on the weight of the core. In one embodiment, the gypsum may be present in an amount of 0 wt. % based on the weight of the core. In addition, it should be understood that the aforementioned weight percentages may also apply to the amount of the gypsum based on the weight of the cement panel. Further, it should be understood that the aforementioned weight percentages may also apply to the amount of the gypsum based on the weight of the slurry.

In general, the cement(s) may be present in the core in an amount of 1 wt. % or more, such as 5 wt. % or more, such as 10 wt. % or more, such as 15 wt. % or more, such as 20 wt. % or more, such as 25 wt. % or more, such as 30 wt. % or more, 35 wt. % or more, such as 40 wt. % or more, such as 45 wt. % or more, such as 50 wt. % or more based on the weight of the core. The cement(s) may be present in the core in an amount of less than 100 wt. %, such as 90 wt. % or less, such as 85 wt. % or less, such as 80 wt. % or less, such as 70 wt. % or less, such as 60 wt. % or less, such as 50 wt. % or less, such as 40 wt. % or less, such as 30 wt. % or less, such as 25 wt. % or less, such as 20 wt. % or less based on the weight of the core. In addition, it should be understood that the aforementioned weight percentages may also apply to the amount of the cement(s) based on the weight of the cement panel. Further, it should be understood that the aforementioned weight percentages may also apply to the amount of the cement(s) based on the weight of the slurry. In addition, the aforementioned percentages may also apply to a particular species of cement.

In general, the pozzolan material(s) may be present in the cement core in an amount of 1 wt. % or more, such as 5 wt. % or more, such as 10 wt. % or more, such as 15 wt. % or more, such as 20 wt. % or more, such as 25 wt. % or more, such as 30 wt. % or more, 35 wt. % or more, such as 40 wt. % or more, such as 45 wt. % or more, such as 50 wt. % or more based on the weight of the core. The pozzolan material(s) may be present in the core in an amount of less than 100 wt. %, such as 90 wt. % or less, such as 85 wt. % or less, such as 80 wt. % or less, such as 70 wt. % or less, such as 60 wt. % or less, such as 50 wt. % or less, such as 40 wt. % or less, such as 30 wt. % or less, such as 25 wt. % or less, such as 20 wt. % or less based on the weight of the core. In addition, it should be understood that the aforementioned weight percentages may also apply to the amount of the pozzolan material(s) based on the weight of the cement panel. Further, it should be understood that the aforementioned weight percentages may also apply to the amount of the pozzolan material(s) based on the weight of the slurry. In addition, the aforementioned percentages may also apply to a particular species of pozzolan material.

In one embodiment, the cement core binder may include a combination of a cement and a pozzolan material. For instance, the weight ratio of the total weight of the pozzolan materials to the total weight of the pozzolan materials may be 0.01 or more, such as 0.1 or more, such as 0.1 or more, such as 0.2 or more, such as 0.5 or more, such as 0.8 or more, such as 1 or more, such as 1.5 or more, such as 2 or more, such as 2.5 or more, such as 3 or more, such as 4 or more, such as 5 or more. The weight ratio may be 50 or less, such as 40 or less, such as 30 or less, such as 20 or less, such as 15 or less, such as 10 or less, such as 8 or less, such as 6 or less, such as 5 or less, such as 4 or less, such as 3 or less, such as 2.5 or less, such as 2 or less, such as 1.5 or less, such as 1 or less, such as 0.5 or less, such as 0.4 or less.

In general, the cement core binder(s) may be present in the core in an amount of 25 wt. % or more, such as 30 wt. % or more, 35 wt. % or more, such as 40 wt. % or more, such as 45 wt. % or more, such as 50 wt. % or more, such as 55 wt. % or more, such as 60 wt. % or more, such as 65 wt. % or more based on the weight of the core. The cement core binder(s) may be present in the core in an amount of less than 100 wt. %, such as 98 wt. % or less, such as 95 wt. % or less, such as 90 wt. % or less, such as 85 wt. % or less, such as 80 wt. % or less, such as 75 wt. % or less, such as 70 wt. % or less, such as 65 wt. % or less, such as 60 wt. % or less based on the weight of the core. In addition, it should be understood that the aforementioned weight percentages may also apply to the amount of the cement core binder(s) based on the weight of the cement panel. Further, it should be understood that the aforementioned weight percentages may also apply to the amount of the cement core binder(s) based on the weight of the slurry.

The cement core may also include aggregates. For instance, the aggregates may include normal weight aggregates, lightweight aggregates, or a mixture thereof. In one embodiment, the cement core includes normal weight aggregates. In a further embodiment, the cement core includes lightweight aggregates. In an even further embodiment, the cement core includes a mixture of normal weight aggregates and lightweight aggregates. However, in addition to the above, it should be understood that the aggregates may also include heavy weight aggregates.

In general, normal weight aggregate may have a density of 1,100 kg/m³ or more, such as 1,300 kg/m³ or more, such as 1,500 kg/m³ or more to 2,100 kg/m³ or less, such as 2,000 kg/m³ or less, such as 1,800 kg/m³ or less, such as 1,600 kg/m³ or less. Meanwhile, lightweight aggregate may have a density of less than 1,100 kg/m³, such as 1,000 kg/m³ or less, such as 900 kg/m³ or less, such as 800 kg/m³ or less, such as 700 kg/m³ or less, such as 600 kg/m³ or less. In addition, heavy weight aggregate may have a density of greater than 2,100 kg/m³.

In general, the normal weight aggregate may include any normal weight aggregate as generally known in the art. For instance, the normal weight aggregate may include, but is not limited to, sand, stone (e.g., crushed stone), limestone, shale, clay, recycled concrete, granite or other minerals, and the like, or a mixture thereof. In one embodiment, the normal weight aggregate includes sand (e.g., mortar grade sand). In another embodiment, the normal weight aggregate includes stone. In a further embodiment, the normal weight aggregate includes limestone. In an even further embodiment, the normal weight aggregate includes granite. In one embodiment, the normal weight aggregate includes at least two, such as at least three, such as at least four normal weight aggregates.

In general, the lightweight aggregate may include a material having a cellular or internal porous microstructures. For instance, the lightweight aggregate may include, but is not limited to, expanded shale, clay (e.g., expanded clay), foamed slag, sintered fly ash, vermiculite (e.g., expanded vermiculite), perlite (e.g., expanded perlite), pumice (e.g., expanded pumice), expanded glass (e.g., expanded closed-cell glass beads), polystyrene (e.g., expanded polystyrene beads, expanded or unexpanded closed-cell polystyrene beads), polyurethane, hollow spheres (e.g., ceramic hollow spheres, glass hollow spheres, plastic hollow spheres, geopolymer hollow spheres, fly ash hollow spheres, silicate hollow spheres, or a mixture there), and the like, or a mixture thereof. In one embodiment, the lightweight aggregate includes polystyrene. In another embodiment, the lightweight aggregate includes expanded glass. In a further embodiment, the lightweight aggregate includes hollow spheres. In one embodiment, the lightweight aggregate includes at least two, such as at least three, such as at least four lightweight aggregates.

As indicated above, in one embodiment, the lightweight aggregate includes polystyrene. For instance, the polystyrene may include polystyrene beads, such as closed-cell polystyrene beads. Such polystyrene beads may be expanded polystyrene beads. The expanded polystyrene beads may have a particular size distribution. For instance, when taking into account all of the expanded beads, the average diameter of the expanded polystyrene beads may be 0.01 inches or more, such as 0.015 inches or more, such as 0.02 inches or more, such as 0.03 inches or more, such as 0.04 inches or more, such as 0.05 inches or more, such as 0.06 inches or more, such as 0.07 inches or more, such as 0.08 inches or more, such as 0.09 inches or more, such as 0.1 inches or more, such as 0.11 inches or more, such as 0.12 inches or more, such as 0.13 inches or more, such as 0.14 inches or more, such as 0.15 inches or more. The dimeter may be 0.5 inches or less, such as 0.4 inches or less, such as 0.3 inches or less, such as 0.25 inches or less, such as 0.2 inches or less, such as 0.18 inches or less, such as 0.15 inches or less, such as 0.13 inches or less, such as 0.12 inches or less, such as 0.11 inches or less, such as 0.1 inches or less, such as 0.09 inches or less, such as 0.08 inches or less, such as 0.07 inches or less, such as 0.06 inches or less, such as 0.05 inches or less, such as 0.04 inches or less, such as 0.03 inches or less, such as 0.02 inches or less.

In one embodiment, the expanded polystyrene beads may have a unimodal size distribution wherein the average diameter is within the aforementioned range. In another embodiment, the expanded polystyrene beads may have a bimodal size distribution. For instance, a first set of expanded polystyrene beads may have an average diameter less than a second set of expanded polystyrene beads. The first set of expanded polystyrene beads may have an average diameter within the aforementioned range. Also, the second set of expanded polystyrene beads may also have an average diameter within the aforementioned range. Regardless, the first set has an average diameter less than the second set. Furthermore, the first set having an average diameter less than the second set may be present in an amount of 10 wt. % or more, such as 15 wt. % or more, such as 20 wt. % or more, such as 25 wt. % or more, such as 30 wt. % or more, such as 35 wt. % or more, such as 40 wt. % or more, such as 45 wt. % or more, such as 50 wt. % or more to less than 100 wt. %, such as 90 wt. % or less, such as 80 wt. % or less, such as 70 wt. % or less, such as 60 wt. % or less, such as 50 wt. % or less based on the total weight of the expanded polystyrene beads. In this regard, the balance may be occupied by the second set of expanded polystyrene beads.

The polystyrene beads and means for expanding are further described in U.S. Pat. No. 9,499,980, which is hereby incorporated by reference in its entirety.

The composition of the aggregates is not generally limited by the present invention. It should be understood by a person skilled in the art that the composition may at least be partially dictated by the desired density of the cement panel. For example, the aggregates and concentrations thereof may be selected based on the desired density of the cement panel.

In general, the aggregate(s) may be present in the cement core in an amount of 0.1 wt. % or more, such as 0.3 wt. % or more, such as 0.5 wt. % or more, such as 1 wt. % or more, such as 2 wt. % or more, such as 5 wt. % or more, such as 10 wt. % or more, such as 15 wt. % or more, such as 20 wt. % or more, such as 25 wt. % or more, such as 30 wt. % or more based on the weight of the cement core. The aggregate(s) may be present in the cement core in an amount of 50 wt. % or less, such as 45 wt. % or less, such as 40 wt. % or less, such as 35 wt. % or less, such as 30 wt. % or less, such as 25 wt. % or less, such as 20 wt. % or less, such as 15 wt. % or less, such as 10 wt. % or less, such as 8 wt. % or less, such as 5 wt. % or less, such as 4 wt. % or less, such as 3 wt. % or less, such as 2 wt. % or less based on the weight of the cement core. In addition, it should be understood that the aforementioned weight percentages may also apply to the amount of the aggregate(s) based on the weight of the cement panel. Further, it should be understood that the aforementioned weight percentages may also apply to the amount of the aggregate(s) based on the weight of the slurry. In addition, the aforementioned percentages may also apply to a particular species of aggregate.

Also, it should be understood that the aforementioned weight percentages may apply individually to the normal weight aggregates. Furthermore, it should be understood that the aforementioned weight percentages may apply individually to the lightweight aggregates. When both a normal weight aggregate and a lightweight aggregate are utilized, they may be present within a specific weight ratio. For instance, the weight ratio of the normal weight aggregate to the lightweight aggregate may be 0.01 or more, such as 0.05 or more, such as 0.1 or more, such as 0.2 or more, such as 0.3 or more, such as 0.5 or more, such as 1 or more. The weight ratio may be 20 or less, such as 15 or less, such as 10 or less, such as 8 or less, such as 6 or less, such as 4 or less, such as 2 or less, such as 1.5 or less, such as 1 or less, such as 0.8 or less, such as 0.6 or less, such as 0.5 or less.

The cement core may also include a chemical set admixture. For instance, the chemical set admixture may be utilized to alter the hydration or properties of the slurry. For instance, such admixture may include a retarder, an accelerator, and the like, or a mixture thereof. In one embodiment, the admixture may include at least a retarder. In another embodiment, the admixture may include at least an accelerator.

In general, the chemical set admixture may include, but is not limited to, lithium salts (e.g., lithium carbonate), sodium tripolyphostate, alkanolamines (e.g., triethanolamine), nitrites (e.g., calcium nitrite, sodium nitrite, etc.) calcium formate, sulfates (e.g., aluminum sulfate, sodium sulfate, calcium sulfate), sodium carbonate, calcium chloride, silicates (e.g., magnesium fluorosilicate, sodium silicate), calcium hydroxide, calcium-aluminate cement, boric acid, borax, formic acid, citric acid, sodium citrate, sodium gluconate, glucose, sucrose, fructose, or a mixture thereof. In one embodiment, the admixture may include a nitrite. In another embodiment, the admixture may include a sulfate. In a further embodiment, the admixture may include citric acid. In an even further embodiment, the admixture may include a sodium citrate. In one embodiment, the admixture includes at least two, such as at least three, such as at least four components.

In general, the chemical set admixture(s) may be present in the cement core in an amount of 0 wt. % or more, such as 0.0001 wt. % or more, such as 0.001 wt. % or more, such as 0.01 wt. % or more, such as 0.1 wt. % or more, such as 0.2 wt. % or more, such as 0.5 wt. % or more, such as 1 wt. % or more, such as 1.5 wt. % or more, such as 2 wt. % or more, such as 2.5 wt. % or more, such as 3 wt. % or more, such as 5 wt. % or more based on the weight of the cement core. The chemical set admixture(s) may be present in the cement core in an amount of 20 wt. % or less, such as 15 wt. % or less, such as 13 wt. % or less, such as 10 wt. % or less, such as 9 wt. % or less, such as 8 wt. % or less, such as 6 wt. % or less, such as 5 wt. % or less, such as 4 wt. % or less, such as 3 wt. % or less, such as 2.5 wt. % or less, such as 2 wt. % or less, such as 1.5 wt. % or less, such as 1 wt. % or less, such as 0.5 wt. % or less, such as 0.3 wt. % or less, such as 0.1 wt. % or less based on the weight of the cement core. In addition, it should be understood that the aforementioned weight percentages may also apply to the amount of the chemical set admixture(s) based on the weight of the cement panel. Further, it should be understood that the aforementioned weight percentages may also apply to the amount of the chemical set admixture(s) based on the weight of the slurry. In addition, the aforementioned percentages may also apply to a particular species within the chemical set admixture.

The cement core may also include a rheological admixture. For instance, the rheological admixture may be utilized to alter the water reduction or rheology of the slurry.

In general, the rheological admixture may include, but is not limited to, sulfonates (e.g., melamine sulfonate, sodium naphthalene sulfonate, lignosulfonates, etc.), cellulose polymer derivatives (e.g., ethyl cellulose, hydroxypropyl methyl cellulose, hydroxyethyl cellulose, etc.), hydrophobically modified alkali swellable emulsions or hydrophobically modified ethoxylate urethanes, molecular rheology modifiers, polysaccharides (e.g., Wellan gum, xantham gum, etc.), galactomannans (e.g., guar gum, carob gum, etc.), and the like, or a mixture thereof. In one embodiment, the admixture may include a sulfonate. In another embodiment, the admixture may include a cellulose polymer derivative. In a further embodiment, the admixture may include a polysaccharide. In one embodiment, the admixture includes at least two, such as at least three, such as at least four components.

In general, the rheological admixture(s) may be present in the cement core in an amount of 0 wt. % or more, such as 0.1 wt. % or more, such as 0.2 wt. % or more, such as 0.5 wt. % or more, such as 1 wt. % or more, such as 1.5 wt. % or more, such as 2 wt. % or more, such as 2.5 wt. % or more, such as 3 wt. % or more, such as 5 wt. % or more based on the weight of the cement core. The rheological admixture(s) may be present in the cement core in an amount of 10 wt. % or less, such as 8 wt. % or less, such as 6 wt. % or less, such as 6 wt. % or less, such as 5 wt. % or less, such as 4 wt. % or less, such as 3 wt. % or less, such as 2.5 wt. % or less, such as 2 wt. % or less, such as 1.75 wt. % or less, such as 1.5 wt. % or less, such as 1 wt. % or less, such as 0.8 wt. % or less based on the weight of the cement core. In addition, it should be understood that the aforementioned weight percentages may also apply to the amount of the rheological admixture(s) based on the weight of the cement panel. Further, it should be understood that the aforementioned weight percentages may also apply to the amount of the rheological admixture(s) based on the weight of the slurry. In addition, the aforementioned percentages may also apply to a particular species within the rheological admixture.

The cement core may also include a surfactant. For instance, the surfactant may include those as generally known in the art. In general, the surfactant may have an HLB value of 5 or more, such as 8 or more, such as 10 or more, such as 12 or more, such as 15 or more, such as 18 or more. The HLB value may be 25 or less, such as 20 or less, such as 18 or less, such as 15 or less, such as 13 or less, such as 10 or less.

The surfactant may include a nonionic surfactant, an anionic surfactant, a cationic surfactant, or a mixture thereof. In one embodiment, the surfactant may include at least an anionic surfactant. In another embodiment, the surfactant may include at least a nonionic surfactant. In a further embodiment, the surfactant may include at least a cationic surfactant. In one particular embodiment, the surfactant may include a combination of an anionic surfactant and a nonionic surfactant.

As indicated above, in one embodiment, the surfactant may include an anionic surfactant. In general, anionic surfactants include those having one or more negatively charged functional groups. For instance, the anionic surfactant includes alkali metal or ammonium salts of alkyl, aryl or alkylaryl sulfonates, sulfates, phosphates. For instance, the anionic surfactant may include sodium lauryl sulfate, sodium octylphenol glycolether sulfate, sodium dodecylbenzene sulfonate, sodium lauryldiglycol sulfate, ammonium tritertiarybutyl phenol and penta- and octa-glycol sulfonates, sulfosuccinate salts such as disodium ethoxylated nonylphenol half ester of sulfosuccinic acid, disodium n-octyldecyl sulfosuccinate, sodium dioctyl sulfosuccinate, alpha olefin sulfonate, and mixtures thereof. Other examples include a C₈-C₂₂ alkyl fatty acid salt of an alkali metal, alkaline earth metal, ammonium, alkyl substituted ammonium, for example, isopropylamine salt, or alkanolammonium salt, a C₈-C₂₂ alkyl fatty acid ester, a C₈-C₂₂ alkyl fatty acid ester salt, and alkyl ether carboxylates.

In one particular embodiment, the anionic surfactant includes a water-soluble salt, particularly an alkali metal salt, of an organic sulfur reaction product having in their molecular structure an alkyl radical containing from about 8 to 22 carbon atoms and a radical selected from the group consisting of sulfonic and sulfuric acid ester radicals. Organic sulfur based anionic surfactants include the salts of C₁₀-C₁₆ alkylbenzene sulfonates, C₁₀-C₂₂ alkane sulfonates, C₁₀-C₂₂ alkyl ether sulfates, C₁₀-C₂₂ alkyl sulfates, C₄-C₁₀ dialkylsulfosuccinates, C₁₀-C₂₂ acyl isothionates, alkyl diphenyloxide sulfonates, alkyl naphthalene sulfonates, C₁₀-C₂₀ alpha olefin sulfonates, and 2-acetamido hexadecane sulfonates. Organic phosphate based anionic surfactants include organic phosphate esters such as complex mono- or diester phosphates of hydroxyl-terminated alkoxide condensates, or salts thereof. Included in the organic phosphate esters are phosphate ester derivatives of polyoxyalkylated alkylaryl phosphate esters, of ethoxylated linear alcohols and ethoxylates of phenol. Particular examples of anionic surfactants include a polyoxyethylene alkyl ether sulfuric ester salt, a polyoxyethylene alkylphenyl ether sulfuric ester salt, polyoxyethylene styrenated alkylether ammonium sulfate, polyoxymethylene alkylphenyl ether ammonium sulfate, and the like, and mixtures thereof. For instance, the anionic surfactant may include a polyoxyethylene alkyl ether sulfuric ester salt, a polyoxyethylene alkylphenyl ether sulfuric ester salt, or a mixture thereof.

As indicated above, in one embodiment, the surfactant may include a non-ionic surfactant. The non-ionic surfactant may be generally as known in the art. Generally, nonionic surfactants include, but are not limited to, amine oxides, fatty acid amides, ethoxylates (e.g., ethoxylated fatty acids, ethoxylated fatty alcohols, etc.), block copolymers of polyethylene glycol and polypropylene glycol, glycerol alkyl esters, alkyl polyglucosides, polyoxyethylene glycol octylphenol ethers, sorbitan alkyl esters, polyoxyethylene glycol sorbitan alkyl esters, and mixtures thereof. For instance, the non-ionic surfactant may include a polyethylene oxide condensate of an alkyl phenol (e.g., the condensation product of an alkyl phenol having an alkyl group containing from 6 to 12 carbon atoms in either a straight chain or branched chain configuration, with ethylene oxide (e.g., present in amounts equal to 1 to 40 moles)). The alkyl substituent may be derived, for example, from polymerized propylene, di-isobutylene, octane or nonene. Other examples include dodecylphenol condensed with 12 moles of ethylene oxide per mole of phenol; dinonylphenol condensed with 5 moles of ethylene oxide per mole of phenol; nonylphenol condensed with 9 moles of ethylene oxide per mole of nonylphenol and di-iso-octylphenol condensed with 5 moles of ethylene oxide. The non-ionic surfactant may be a condensation product of a primary or secondary aliphatic alcohol having from 8 to 24 carbon atoms, in either straight chain or branched chain configuration, with from 1 to about 40 moles of alkylene oxide per mole of alcohol. The non-ionic surfactant may include a compound formed by condensing ethylene oxide with a hydrophobic base formed by the condensation of propylene oxide with propylene glycol (e.g., Pluronics).

As indicated above, in one embodiment, the surfactant may include a cationic surfactant. Examples of the cationic surfactant may include water-soluble quaternary ammonium compounds, polyammonium salts, a polyoxyethylene alkylamine and the like.

In general, the surfactant(s) may be present in the cement core in an amount of 0 wt. % or more, such as 0.0001 wt. % or more, such as 0.0005 wt. % or more, such as 0.001 wt. % or more, such as 0.005 wt. % or more, such as 0.01 wt. % or more, such as 0.05 wt. % or more, such as 0.1 wt. % or more based on the weight of the cement core. The surfactant(s) may be present in the cement core in an amount of 5 wt. % or less, such as 4 wt. % or less, such as 3 wt. % or less, such as 2 wt. % or less, such as 1 wt. % or less, such as 0.8 wt. % or less, such as 0.5 wt. % or less, such as 0.3 wt. % or less, such as 0.2 wt. % or less, such as 0.15 wt. % or less, such as 0.1 wt. % or less, such as 0.08 wt. % or less, such as 0.05 wt. % or less, such as 0.03 wt. % or less, such as 0.01 wt. % or less, such as 0.005 wt. % or less, such as 0.001 wt. % or less based on the weight of the cement core. In one embodiment, a surfactant may not be utilized such that the weight percentage is 0. In addition, it should be understood that the aforementioned weight percentages may also apply to the amount of the surfactant(s) based on the weight of the cement panel. Further, it should be understood that the aforementioned weight percentages may also apply to the amount of the surfactant(s) based on the weight of the slurry.

The slurry utilized in making the cement panel also includes water. Water may be employed for fluidity and also for rehydration of the stucco to allow for setting. The amount of water utilized is not necessarily limited by the present invention.

The water may be present in the slurry in an amount of 1 wt. % or more, such as 3 wt. % or more, such as 5 wt. % or more, such as 7 wt. % or more, such as 9 wt. % or more, such as 10 wt. % or more, such as 13 wt. % or more, such as 15 wt. % or more based on the weight of the slurry. The water may be present in the slurry in an amount of 40 wt. % or less, such as 30 wt. % or less, such as 25 wt. % or less, such as 20 wt. % or less, such as 15 wt. % or less, such as 10 wt. % or less based on the weight of the slurry.

For instance, the weight ratio of the water to the binders in the slurry may be 0.001 or more, such as 0.01 or more, such as 0.05 or more, such as 0.1 or more, such as 0.13 or more, such as 0.15 or more, such as 0.17 or more, such as 0.2 or more, such as 0.3 or more, such as 0.5 or more. The weight ratio of the water to the binders in the slurry may be 2 or less, such as 1.5 or less, such as 1.3 or less, such as 1 or less, such as 0.8 or less, such as 0.6 or less, such as 0.5 or less, such as 0.4 or less, such as 0.3 or less, such as 0.25 or less, such as 0.2 or less, such as 0.15 or less.

In addition, the slurry may have a particular pH. For instance, the slurry may be basic or alkaline. In this regard, the pH may be more than 7, such as 8 or more, such as 9 or more, such as 10 or more, such as 11 or more, such as 11.5 or more, such as 12 or more, such as 12.5 or more. The pH may be 14 or less, such as 13.5 or less, such as 13 or less.

In addition to the binders and water, the slurry may also include any other conventional additives as known in the art. Accordingly, these conventional additives may also be present in the cement core and panel. In this regard, such additives are not necessarily limited by the present invention. For instance, the additives may include dispersants, foam or foaming agents, biocides (such as bactericides and/or fungicides), adhesives, pH adjusters, leveling agents, non-leveling agents, starches (such as pregelatinized starch, non-pregelatinized starch, and/or an acid modified starch), colorants, fire retardants, fillers (e.g., fibers), etc.

For example, in one embodiment, the additives may include fibers. The fibers may include natural fibers, synthetic fibers, or a mixture thereof. In one embodiment, the fibers may include naturals fibers. In another embodiment, the fibers may include synthetic fibers. In a further embodiment, the fibers may include a mixture of natural fibers and synthetic fibers. The fibers are not necessarily limited and may include those generally utilized in the art. The fibers may include, but are not limited to, cellulose, hemp, cotton, basalt, polyester, polypropylene, polyvinyl alcohol, nylon, alkali resistant glass, carbon, glass, etc., or a mixture thereof. In one embodiment, the fibers may include cellulose. In another embodiment, the fibers may include glass. In a further embodiment, the fibers may include polypropylene. In an even further embodiment, the fibers may include nylon.

In general, it should be understood that the types and amounts of such additives are not necessarily limited by the present invention. When present, each additive may be present in the slurry in an amount of 0.0001 wt. % or more, such as 0.001 wt. % or more, such as 0.01 wt. % or more, such as 0.02 wt. % or more, such as 0.05 wt. % or more, such as 0.1 wt. % or more, such as 0.15 wt. % or more, such as 0.2 wt. % or more, such as 0.25 wt. % or more, such as 0.3 wt. % or more, such as 0.5 wt. % or more, such as 1 wt. % or more, such as 2 wt. % or more based on the weight of the cement core The additive may be present in an amount of 20 wt. % or less, such as 15 wt. % or less, 10 wt. % or less, such as 7 wt. % or less, such as 5 wt. % or less, such as 4 wt. % or less, such as 3 wt. % or less, such as 2.5 wt. % or less, such as 2 wt. % or less, such as 1.8 wt. % or less, such as 1.5 wt. % or less, such as 1 wt. % or less, such as 0.8 wt. % or less, such as 0.6 wt. % or less, such as 0.5 wt. % or less, such as 0.4 wt. % or less, such as 0.35 wt. % or less, such as 0.2 wt. % or less based on the weight of the cement core. In addition, it should be understood that the aforementioned weight percentages may also apply to the amount of the additive(s) based on the weight of the cement panel. Further, it should be understood that the aforementioned weight percentages may also apply to the amount of the additive(s) based on the weight of the slurry.

In general, the cement core has a first surface and a second surface opposite the first surface. The cement panel may also include a facing material, for example on a surface thereof. In this regard, the cement panel may include any facing material as generally known in the art and/or as previously disclosed herein (e.g., glass mat facing material). In one embodiment, the facing material may be disposed directly on the surface. Also, in one embodiment, the facing material may be provided with an adhesive between the facing material and the cement core. In one embodiment, the facing material may be provided such that it is embedded at least to a certain degree within the cement core. Accordingly, for embedding the facing material, it may have openings sufficiently large to permit penetration of the slurry into and through the openings, which can permit bonding (e.g., mechanical bonding) of the facing material to the cement core. The facing material may be embedded a depth such that it is not visible. However, the pattern it creates on a surface may be slightly visible. For instance, the facing material may be embedded at a depth of about 0.1 mm or more, such as 0.2 mm or more, such as 0.3 mm or more, such as 0.4 mm or more, such as 0.5 mm or more, such as 0.8 mm or more, such as 1 mm or more. The depth may be 5 mm or less, such as 4 mm or less, such as 3 mm or less, such as 2 mm or less, such as 1.5 mm or less, such as 1.3 mm or less, such as 1 mm or less, such as 0.8 mm or less, such as 0.6 mm or less, such as 0.5 mm or less, such as 0.4 mm or less. The facing material may be embedded by applying a vibration to the slurry such that it can assist in the creation of a strong bond between the facing material and the slurry.

It should be understood that the facing materials employed in the cement panel may be all of the same type of material. Alternatively, it should also be understood that the facing materials employed in the cement panel may be of different types of materials.

The thickness of the facing material is not necessarily limited. For instance, the facing material may have a thickness of 0.01 mm or more, such as 0.05 mm or more, such as 0.1 mm or more, such as 0.2 mm or more, such as 0.25 mm or more, such as 0.3 mm or more, such as 0.5 mm or more, such as 1 mm or more, such as 2 mm or more, such as 3 mm or more, such as 5 mm or more, such as 7 mm or more, such as 9 mm or more, such as 10 mm or more. The facing material may have a thickness of 50 mm or less, such as 40 mm or less, such as 30 mm or less, such as 25 mm or less, such as 20 mm or less, such as 18 mm or less, such as 15 mm or less, such as 14 mm or less, such as 13 mm or less, such as 12 mm or less, such as 11 mm or less, such as 10 mm or less, such as 9 mm or less, such as 8 mm or less, such as 7 mm or less, such as 6 mm or less, such as 5 mm or less, such as 4 mm or less, such as 3 mm or less, such as 2 mm or less, such as 1 mm or less, such as 0.8 mm or less, such as 0.6 mm or less, such as 0.5 mm or less, such as 0.4 mm or less, such as 0.3 mm or less, such as 0.2 mm or less.

The present invention is also directed to a method of making a cement panel. The method may include a step of combining water and at least one binder. The method may also include combining any of the other aforementioned additives to form the slurry.

The manner in which the additives are combined is not necessarily limited. For instance, the slurry can be made using any method or device generally known in the art. In particular, the components of the slurry can be mixed or combined using any method or device generally known in the art. For instance, the components of the slurry may be combined in any type of device, such as a mixer and in particular a pin mixer.

As indicated above, the facing material may be provided on either or both sides of the cement core. In this regard, in one embodiment, the facing material may be provided prior to deposition of the slurry. For instance, the method may include a step of depositing the slurry onto a facing material. For instance, the facing material may be conveyed on a conveyor system (i.e., a continuous system for continuous manufacture of cement panel). In this regard, the slurry may be directly deposited onto the facing material. Next, after depositing the slurry, a facing material may be provided on top of the slurry such that the slurry is sandwiched between the facing materials in order to form the cement panel. When the facing materials are provided, they may be provided in such a manner as to provide a reinforced edge. For example, they may be provided such that the facing material covering one surface of the cement core wraps around a side edge so as to at least partially, and in one embodiment not completely, cover the facing material on the opposite side of the cement core. Without intending to be limited by theory, such wrap-around may augment the strength of the cement panel at the border edge regions thereby allowing the panel to retain sufficient structural integrity when a fastener, such as a screw or nail, is installed near the edge.

In addition or alternatively, edge strips may be utilized as disclosed at least in U.S. Pat. No. 9,499,980, which is hereby incorporated by reference in its entirety. For instance, edge strips may generally have a U-shaped configuration and adhere to respective marginal areas. The edge strips may be adhered to the longitudinal edge face, merely abut the longitudinal edge face or be spaced apart from the longitudinal face. The edge strip may, for example take on a U-shaped configuration as discussed herein. Alternatively, if desired, the longitudinal edge face or a part thereof may be open (i.e. not covered by an edge strip). In this latter case, one or both of the marginal areas adjacent a longitudinal edge on opposite broad or major faces may be provided with an edge reinforcing member.

The edge strips may be made of the same material as the facing materials disclosed therein. In one embodiment, the edge strips may be woven. For instance, the edge strips may be a mesh. In another embodiment, the edge strips may be non-woven. For instance, the edge strips may be a mat.

Regardless, examples of materials may include glass, steel, polyester, aramid resin, polyolefin, nylon fibers, polyvinylidene fluoride, polytetrafluoroethylene, cellulosics, and the like. In one particular embodiment, the material may be a polyester or a polyolefin. For example, the material may be a polyester (e.g., poly(ethylene terephthalate). Alternatively, the material may be a polyolefin (e.g., polyethylene, polypropylene, etc.). Regardless, the edge strips may be made of a material allowing for relatively tight interstices such that it is generally impervious to the slurry.

The edge strips may be applied and bonded in any manner utilized in the art. For example, the edge strips may be applied utilizing an adhesive. In one embodiment, the edge strips may be applied such that they are on the exterior of the cement panel. For example, they may be placed on the cement panel after providing the facing materials.

Regardless of the configuration, after deposition of the slurry, the binder(s) reacts with the water to convert or set the binder(s). Such reaction may allow for the cement to set and become firm thereby allowing for the continuous sheet to be cut into cement panels at the desired length. In this regard, the method may comprise a step of reacting the binder(s) with water or allowing the binder(s) to convert or hydrate. In this regard, the method may allow for the slurry to set to form a cement panel.

The method may also comprise a step of cutting a continuous cement panel sheet into a cement panel. Then, after the cutting step, the method may comprise a step of supplying the cement panel to a heating device. For instance, such heating device may be a kiln and may allow for removal of any free water. The temperature and time required for heating in such heating device are not necessarily limited by the present invention.

While the above generally discloses a method for making a cement panel, it should be understood that such general method is disclosed in the art. For instance, general methods are disclosed at least in U.S. Pat. No. 9,499,980, which is hereby incorporated by reference in its entirety.

The thickness of the cement panel, and in particular, the cement core, is not necessarily limited and may be from about 0.25 inches to about 1 inch. For instance, the thickness may be at least ¼ inches, such as at least 5/16 inches, such as at least ⅜ inches, such as at least 7/16 inches, such as at least ½ inches, such as at least ⅝ inches, such as at least ¾ inches, such as at least 1 inch, such as at least 1.5 inches, such as at least 2 inches. In this regard, the thickness may be about any one of the aforementioned values. For instance, the thickness may be about ¼ inches. Alternatively, the thickness may be about ⅜ inches. In one embodiment, the thickness may be about 7/16 inches. In another embodiment, the thickness may be about ½ inches. In a further embodiment, the thickness may be about ⅝ inches. In another embodiment, the thickness may be about ¾ inches. In another further embodiment, thickness may be about 1 inch. With regard to the thickness, the term “about” may be defined as within 5%, such as within 4%, such as within 3%, such as within 2%, such as within 1%.

In addition, the weight of the cement panel is not necessarily limited. For instance, the cement panel may have a weight of 0.5 lbs/ft² or more, such as 1 lb/ft² or more, such as 1.3 lbs/ft² or more, such as 1.5 lbs/ft² or more, such as 1.8 lbs/ft² or more, such as 2 lbs/ft² or more, such as 2.3 lbs/ft² or more, such as 2.5 lbs/ft² or more, such as 2.8 lbs/ft² or more, such as 3 lbs/ft² or more, such as 3.3 lbs/ft² or more, such as 3.5 lbs/ft² or more, such as 3.8 lbs/ft² or more, such as 4 lbs/ft² or more. The weight may be 6 lbs/ft² or less, such as 5.5 lbs/ft² or less, such as 5 lbs/ft² or less, such as 4.8 lbs/ft² or less, such as 4.5 lbs/ft² or less, such as 4.3 lbs/ft² or less, such as 4 lbs/ft² or less, such as 3.8 lbs/ft² or less, such as 3.5 lbs/ft² or less, such as 3.3 lbs/ft² or less, such as 3 lbs/ft² or less, such as 2.8 lbs/ft² or less, such as 2.5 lbs/ft² or less. Such weight may be a dry weight such as after the panel leaves the heating device (e.g., kiln).

The cement panel may have a certain fastener holding, which generally is a measure of the force required to pull a cement panel off of a wall by forcing a fastening nail through the panel. The values obtained from the nail pull test generally indicate the maximum stress achieved while the fastener head penetrates through the panel surface and cement core. In this regard, the cement panel exhibits a fastener holding of at least about 30 lbt, such as at least about 40 lbt, such as at least about 50 lbt, such as at least about 60 lbt, such as at least about 70 lbt, such as at least about 80 lbt, such as at least about 85 lbt, such as at least about 90 lbt, such as at least about 95 lbt, such as at least about 100 lbt, such as at least about 110 lbt, such as at least about 120 lbt, such as at least about 130 lbt, as tested according to ASTM C₁₃₉₆-17 and ASTM C₄₇₃-19. The fastener holding may be about 200 lbt or less, such as 180 lbt or less, such as about 150 lbt or less, such as about 140 lbt or less, such as about 130 lbt or less, such as about 120 lbt or less, such as about 110 lbt or less, such as about 105 lbt or less, such as about 100 lbt or less, such as about 95 lbt or less, such as about 90 lbt or less. Such fastener holding may be based upon the thickness of the cement panel. For instance, when conducting a test, such fastener holding values may vary depending on the thickness of the cement panel. As an example, the fastener holding values above may be for a ⅝ inch cement panel. However, it should be understood that instead of a ⅝ inch cement panel, such fastener holding values may be for any other thickness cement panel as mentioned herein. For instance, such fastener holding values may be for a ¼ inch cement panel, a ½ cement panel, a ¾ inch cement panel, a 1 inch cement panel, etc. In addition, such fastener holding values may be for a wet condition. Alternatively, such values may be for a dry condition. Further, such values may apply to both a wet and dry condition.

The cement panel may have a certain compressive strength. For instance, the compressive strength may be about such as about 250 psi or more, such as about 500 psi or more, such as about 700 psi or more, such as about 900 psi or more, such as about 1,000 psi or more, such as about 1,100 psi or more, such as about 1,200 psi or more, such as about 1,250 psi or more, such as about 1,300 psi or more, such as about 1,500 psi or more as tested according to ASTM D2394. The compressive strength may be about 5,000 psi or less, such as about 4,000 psi or less, such as about 3,000 psi or less, such as about 2,500 psi or less, such as about 2,000 psi or less, such as about 1,800 psi or less, such as about 1,600 psi or less, such as about 1,500 psi or less, such as about 1,400 psi or less, such as about 1,300 psi or less, such as about 1,250 psi or less. Such compressive strength may be based upon the thickness of the cement panel. For instance, when conducting a test, such compressive strength values may vary depending on the thickness of the cement panel. As an example, the compressive strength values above may be for a ⅝ inch cement panel. However, it should be understood that instead of a ⅝ inch cement panel, such compressive strength values may be for any other thickness cement panel as mentioned herein. For instance, such compressive strength values may be for a ¼ inch cement panel, a ½ cement panel, a ¾ inch cement panel, a 1 inch cement panel, etc.

The cement panel may have a certain flexural strength. For instance, the flexural strength may be about such as about 250 psi or more, such as about 350 psi or more, such as about 400 psi or more, such as about 500 psi or more, such as about 600 psi or more, such as about 700 psi or more, such as about 750 psi or more, such as about 800 psi or more, such as about 1,000 psi or more as tested according to ASTM C1396-17 and ASTM C473-19. The flexural strength may be about 3,000 psi or less, such as about 2,500 psi or less, such as about 2,000 psi or less, 1,700 psi or less, such as about 1,500 psi or less, such as about 1,300 psi or less, such as about 1,100 psi or less, such as about 1,000 psi or less, such as about 900 psi or less, such as about 800 psi or less, such as about 750 psi or less. Such flexural strength may be based upon the thickness of the cement panel. For instance, when conducting a test, such flexural strength values may vary depending on the thickness of the cement panel. As an example, the flexural strength values above may be for a ⅝ inch cement panel. However, it should be understood that instead of a ⅝ inch cement panel, such flexural strength values may be for any other thickness cement panel as mentioned herein. For instance, such flexural strength values may be for a ¼ inch cement panel, a ½ cement panel, a ¾ inch cement panel, a 1 inch cement panel, etc.

The cement panel may have a certain modulus of rupture, which generally is a measure of the ability to resist deformation under load. The modulus of rupture may be tested in accordance with ASTM C78. The modulus of rupture may be determined after at least 21 days at 72° F. In this regard, the cement panel exhibits a fastener holding of at least 300 psi, such as at least 400 psi, such as at least 500 psi, such as at least 600 psi, such as at least 700 psi, such as at least 800 psi, such as at least 900 psi, such as at least 1,000 psi, such as at least 1,100 psi, such as at least 1,200 psi. The modulus of rupture may be 2,000 psi or less, such as 1,700 psi or less, such as 1,500 psi or less, such as 1,300 psi or less, such as 1,100 psi or less, such as 1,000 psi or less, such as 900 psi or less, such as 800 psi or less, such as 700 psi or less. Such modulus of rupture may be based upon the thickness of the cement panel. For instance, when conducting a test, such modulus of rupture values may vary depending on the thickness of the cement panel. As an example, the modulus of rupture above may be for a ⅝ inch cement panel. However, it should be understood that instead of a ⅝ inch cement panel, such modulus of rupture may be for any other thickness cement panel as mentioned herein. For instance, such modulus of rupture may be for a ¼ inch cement panel, a ½ cement panel, a ¾ inch cement panel, a 1 inch cement panel, etc.

The gypsum panel disclosed herein may have many applications. For instance, the gypsum panel may be used as a standalone panel in construction for the preparation of walls, roofs, ceilings, floors, etc. As used in the present disclosure, the term “gypsum panel,” generally refers to any panel, sheet, or planar structure, either uniform or formed by connected portions or pieces, that is constructed to at least partially establish one or more physical boundaries. Such existing, installed, or otherwise established or installed wall or ceiling structures comprise materials that may include, as non-limiting examples, gypsum, stone, ceramic, cement, wood, composite, or metal materials. The installed gypsum panel forms part of a building structure, such as a wall, roof, and/or ceiling.

The cement panel disclosed herein may have many applications. For instance, the cement panel may be utilized for interior or exterior applications. The cement panel may be used as a standalone panel in construction for the preparation of walls, ceilings, floors, etc. In addition, it may be utilized in an environment that may generally be humid or wet, such as shower rooms, bathrooms, lock rooms, etc. In addition, it may be utilized in an area requiring high impact resistance. For example, it may be utilized as a substrate for a stucco wall system or a masonry veneer wall system. Once the panel is affixed, as desired or necessary, another material may be affixed thereto such as, for example, ceramic tile, brick, marble panels, stucco or the like. Reinforced cementitious panels or panels having cores formed of a cementitious composition with a surface being reinforced is demonstrated in U.S. Pat. Nos. 1,439,954, 3,284,980, 4,450,022, and 4,916,004, which are hereby incorporated by reference in their entirety. In addition, cement panels with reinforced edges are disclosed in U.S. Pat. No. 6,187,409, which is hereby incorporated by reference in its entirety.

### EXAMPLES

### Example 1

Gypsum panels were formed in accordance with the present disclosure. All of the gypsum panels had a thickness of ⅝ inches. An elastomeric polymeric binder was incorporated into the second facing material of each of the sample gypsum panels in an amount from about 26 wt. % to about 28 wt. % by weight of the second facing material. The second facing material for each sample gypsum panel was a glass mat facing material. As used in Table 2, the term “Back” refers to the second facing material, and the term “Face” refers to the first facing material. All of the Sample panels (i.e., Samples 1-5) were tested in accordance with FM 4470 and had a VSH rating.

TABLE 2

| Sample | Standard | Sample 1 | Sample 2 | Sample 3 | Sample 4 | Sample 5 |
|---|---|---|---|---|---|---|
| Panel Weight | — | 3003 | 3097 | 3103 | 3181 | 2997 |
| [lbs/MSF] | | | | | | |
| Nail Pull | ASTM C1396- | 221 | 230 | 193 | 173 | 187 |
| Strength | 17 | | | | | |
| [lbf] | | | | | | |
| Pull Through | ANSI/SPRI/FM | 412 | 384 | 328 | 362 | 349 |
| Strength | BPT-1 2021 | | | | | |
| [lbf] | | | | | | |
| Compressive | ASTM C473- | 1386 | 1426 | 1329 | 1176 | 1281 |
| Strength | 19 | | | | | |
| [psi] | | | | | | |
| Z-Tensile | ASTM C297 | 53 | 72 | 83 | 64 | 35 |
| Strength | | | | | | |
| (Face) | | | | | | |
| [lbf] | | | | | | |
| Z-Tensile | ASTM C297 | 36 | 50 | 25 | 61 | 20 |
| Strength | | | | | | |
| (Back) | | | | | | |
| [lbf] | | | | | | |
| Flexural | ASTM C473- | 132 | 130 | 106 | 117 | 90 |
| Strength in | 19 | | | | | |
| Parallel | | | | | | |
| Direction | | | | | | |
| (Back) | | | | | | |
| [lbf] | | | | | | |
| Flexural | ASTM C473- | 228 | 196 | 176 | 165 | 183 |
| Strength in | 19 | | | | | |
| Parallel | | | | | | |
| Direction | | | | | | |
| (Face) | | | | | | |
| [lbf] | | | | | | |
| Flexural | ASTM C473- | 195 | 188 | 162 | 162 | 200 |
| Strength in | 19 | | | | | |
| Perpendicular | | | | | | |
| Direction | | | | | | |
| (Back) | | | | | | |
| [lbf] | | | | | | |
| Flexural | ASTM C473- | 278 | 261 | 262 | 253 | 270 |
| Strength in | 19 | | | | | |
| Perpendicular | | | | | | |
| Direction | | | | | | |
| (Face) | | | | | | |
| [lbf] | | | | | | |
| Caliper | — | 0.609 | 0.621 | 0.643 | 0.648 | 0.639 |
| [in] | | | | | | |

While particular embodiments of the present disclosure have been illustrated and described, it would be obvious to those skilled in the art that various other changes and modifications can be made without departing from the spirit and scope of the present disclosure. It is therefore intended to cover in the appended claims all such changes and modifications that are within the scope of this disclosure.

1. A gypsum panel comprising:
a gypsum core, the gypsum core comprising gypsum; and
a first facing material and a second facing material, the first facing material and the second facing material sandwiching the gypsum core, the first facing material, the second facing material, or both comprising glass fibers and one or more binders, the glass fibers being bound by the one or more binders, the one or more binders being present in the first facing material, the second facing material, or both in an amount from about 10 wt. % to about 50 wt. %.

2. The gypsum panel of claim 1, wherein at least one binder of the one or more binders is an acrylic polymer.

3. The gypsum panel of claim 1, where the one or more binders are present in the first facing material, the second facing material, or both in an amount from about 15 wt. % to about 40 wt. %.

4. The gypsum panel of claim 1, where the one or more binders are present in the first facing material, the second facing material, or both in an amount from about 20 wt. % to about 35 wt. %.

5. The gypsum panel of claim 1, wherein the one or more binders have a glass transition temperature from about −100° C. to about 150° C.

6. The gypsum panel of claim 1, wherein the one or more binders have a glass transition temperature from about −30° C. to about 90° C.

7. The gypsum panel of claim 1, wherein the one or more binders have a glass transition temperature from about −30° C. to about 60° C.

8. The gypsum panel of claim 1, wherein the glass fibers have an average fiber diameter from about 5 microns to about 25 microns.

9. The gypsum panel of claim 1, wherein the glass fibers have an average fiber diameter from about 10 microns to about 20 microns.

10. The gypsum panel of claim 1, wherein the glass fibers have an average fiber diameter from about 13 microns to about 18 microns.

11. The gypsum panel of claim 1, wherein the second facing material has a basis weight from about 1.5 lbs/csf to about 3.2 lbs/csf.

12. The gypsum panel of claim 1, wherein the second facing material has a basis weight from about 2.0 lbs/csf to about 3.0 lbs/csf.

13. The gypsum panel of claim 1, wherein the second facing material has a basis weight from about 2.3 lbs/csf to about 2.8 lbs/csf.

14. The gypsum panel of claim 1, wherein the first facing material and the second facing material comprise glass fibers and at least one binder of the one or more binders, wherein the second facing material has a higher basis weight than the first facing material.

15. The gypsum panel of claim 1, wherein the first facing material and the second facing material comprise glass fibers and at least one binder of the one or more binders, the second facing material comprising glass fibers having an average fiber diameter greater than the average fiber diameter of the glass fibers in the first facing material.

16. The gypsum panel of claim 1, wherein the gypsum panel has a weight from about 2000 lbs/MSF to about 3500 lbs/MSF.

17. The gypsum panel of claim 1, wherein the gypsum panel has a weight from about 2400 lbs/MSF to about 3300 lbs/MSF.

18. The gypsum panel of claim 1, wherein the gypsum panel has a VSH rating.

19. The gypsum panel of claim 1, wherein the gypsum panel is a roofing gypsum panel.

20. The gypsum panel of claim 1, wherein the gypsum panel has a density of 40 pcf or more.

21. A method for making the gypsum panel comprising:
providing a first facing material;
depositing a gypsum slurry comprising stucco, water onto the first facing material,
providing a second facing material on the gypsum slurry; and
allowing the stucco to convert to calcium sulfate dihydrate;
wherein the first facing material, the second facing material, or both comprise glass fibers and one or more binders, the glass fibers being bound by the one or more binders, the one or more binders being present in the first facing material, the second facing material, or both in an amount from about 10 wt. % to about 50 wt. %.

21. A cement panel comprising:
a cement core; and
a first facing material and a second facing material, the first facing material and the second facing material sandwiching the cement core, the first facing material, the second facing material, or both comprising glass fibers and one or more binders, the glass fibers being bound by the one or more binders, the one or more binders being present in the first facing material, the second facing material, or both in an amount from about 10 wt. % to about 50 wt. %.
